(19) United States
(12) Patent Application Publication
(10) Pub. No.: US 2010/0003596 A1
(43) Pub. Date: Jan. 7, 2010

(54) ALKALINE BATTERY

(75) Inventors: Satoshi Sato, Fukushima (JP); Minoru Ohnuma, Fukushima (JP)

Correspondence Address: K&L Gates LLP, P. O. BOX 1135, CHICAGO, IL, 60690, US

(73) Assignee: Sony Corporation, Tokyo (JP)

(21) Appl. No.: 12/493,987

(22) Filed: Jun. 29, 2009

(30) Foreign Application Priority Data
Jul. 7, 2008 (JP) P2008-177257

(51) Int. Cl. H01M 6/08; H01M 4/86

(52) U.S. Cl. 429/164; 252/182.1

(57) ABSTRACT

An alkaline battery includes a cathode mix containing a compound oxide of silver, cobalt, and nickel represented by AgₓCo_{y}Ni_{z}O₂ wherein x+y+z=2, x≦1.10, y>0.

### CROSS REFERENCES TO RELATED APPLICATIONS

The present application claims priority to Japanese Priority Patent Application JP 2008-177257 filed in the Japan Patent Office on Jul. 7, 2008, the entire content of which is hereby incorporated by reference.

### BACKGROUND

The present application generally relates to alkaline batteries. In particular, the present application relates to a button-type alkaline battery that uses zinc or a zinc alloy as an anode active material.

Button-type alkaline batteries are used in small electronic appliances such as wristwatches and portable electronic calculators. Button-type alkaline batteries use granulated zinc or a granulated zinc alloy as the anode active material. Granulated zinc or granulated zinc alloys generate hydrogen gas when dissolved in alkaline electrolytes. As granulated zinc or granulated zinc alloys contact copper in current collectors via alkaline electrolytes, hydrogen gas is also generated from the current collectors.

Once hydrogen gas is generated in button-type alkaline batteries, a decrease in capacity retention attributable to hydrogen gas and deterioration of leakage resistance and battery swelling attributable to an increased inner pressure occur. Thus, in the past, generation of hydrogen gas (H₂) has been suppressed by using amalgamated zinc obtained by amalgamating granulated zinc or a granulated zinc alloy.

Recently, environmental issues are arising in various fields and are actively investigated. As for button-type alkaline batteries, many studies have been carried out in finding way to avoid use of mercury which directly damages the environment. For example, Japanese Unexamined Patent Application Publication No. 2002-93427 describes a cathode mix containing silver nickelite (AgNiO₂) that has good hydrogen absorbing property and electrical conductivity, thereby suppressing generation of hydrogen gas from granulated zinc or granulated zinc alloys.

### SUMMARY

However, as the depth of discharge increases, the voltage characteristics of an alkaline battery that uses a cathode mix containing silver nickelite (AgNiO₂) deteriorate due to a decreased electrical conductivity caused by generation of Ni(OH)₂ having a low electrical conductivity. In addition, the efficiency of using the cathode active material decreases with the electrical conductivity.

Thus, it is desirable to provide an alkaline battery that can suppress deterioration of capacity retention caused by generation of hydrogen gas and deterioration of leakage resistance and battery swelling caused by an increased inner pressure and that can achieve high safety and a stable voltage characteristic up to the final stage of discharge.

According to an embodiment, there is provided an alkaline battery that includes a cathode mix containing a compound oxide of silver, cobalt, and nickel represented by formula (1):

AgₓCo_{y}Ni_{z}O₂ (1)

wherein x+y+z=2, x≦1.10, y>0.

Since the battery includes the compound oxide of silver, cobalt, and nickel represented by formula (1), battery characteristics can be improved.

With this battery, the decrease in capacity retention caused by generation of hydrogen gas and deterioration of leakage resistance and battery swelling caused by an increase in inner pressure can be overcome. The battery shows high safety and stable voltage characteristics down to the final stage of discharge.

Additional features and advantages are described herein, and will be apparent from the following Detailed Description and the figures.

### BRIEF DESCRIPTION OF THE FIGURES

FIG. 1 is a cross-sectional view showing the structure of a button-type alkaline battery according to one embodiment;

FIG. 2 is a cross-sectional view of an anode cup of a button-type alkaline battery according to one embodiment; and

FIGS. 3A and 3B are diagrams illustrating the procedure of a hydrogen gas absorption test.

### DETAILED DESCRIPTION

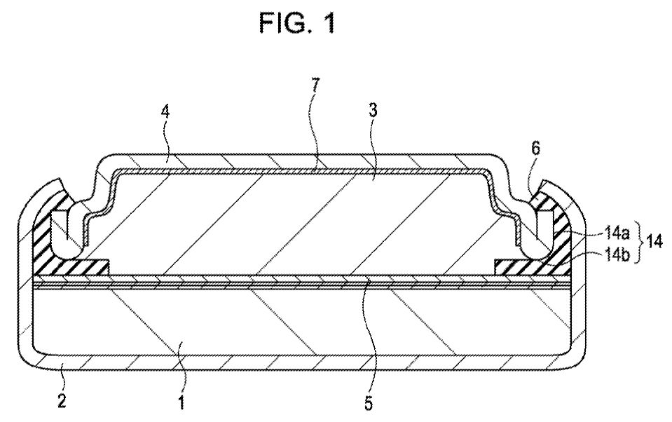

The present application is described below with reference to the drawings according an embodiment. FIG. 1 is a cross-sectional view showing the structure of a button-type alkaline battery according to one embodiment. As shown in FIG. 1, the button-type alkaline battery includes a cathode can 2 having an open end sealed with an anode cup 4 via a ring-shaped gasket 6.

The cathode can 2 is made of a nickel-plated stainless steel or steel plate and serves as a cathode terminal and a cathode current collector. A disk-shaped cathode mix 1 is housed in the cathode can 2.

The cathode mix 1 contains a silver-cobalt-nickel compound oxide represented by formula (1) below, and at least one of silver oxide (Ag₂O), and manganese dioxide (MnO₂). The cathode mix 1 contains a fluorocarbon resin such as polytetrafluoroethylene (PTFE) as a binder. The amount of the silver-cobalt-nickel compound oxide represented by formula (1) is preferably in the range of 1.5 to 60 percent by weight of the cathode mix. In formula (1), preferably, y≧0.01.

AgₓCo_{y}Ni_{z}O₂ (Formula 1)

(wherein x+y+z=2, x≦1.10, and y>0).

The silver-cobalt-nickel compound oxide represented by formula (1) is a material having a high hydrogen gas-reducing property. For example, the silver-cobalt-nickel compound oxide has a higher hydrogen gas-reducing property than silver nickelite (AgNiO₂) proposed in Japanese Unexamined Patent Application Publication No. 2002-93427. The silver-cobalt-nickel compound oxide represented by formula (1) has a discharge potential lower than that of silver nickelite (AgNiO₂). Thus, in forming a mixed potential with Ag₂O or MnO₂, the silver-cobalt-nickel compound oxide can exist down to a discharge depth larger than when silver nickelite (AgNiO₂) is used. The silver-cobalt-nickel compound oxide represented by formula (1) has an electrical conductivity and electrical capacity comparable to those of graphite, and retains high conductive properties also at the final stage of discharge.

The button-type alkaline battery of this embodiment that uses the cathode mix 1 containing the silver-cobalt-nickel compound oxide represented by formula (1) can address the following problems 1 to 7 of button-type alkaline batteries of related art.

Problem 1: A button-type alkaline battery that uses a cathode mix containing manganese dioxide (MnO₂) as a main component suffers from deterioration of leakage resistance and battery burst. In other words, a button-type alkaline battery that uses a cathode mix containing manganese dioxide (MnO₂) as a main component does not contain a substance that rapidly reduces hydrogen gas. Thus, when stored, the inner pressure in the cell increases, resulting in swelling of the cell. As the gas leaks outside, crimped portions become loose and leakage occurs (problem of deterioration of leakage resistance). In the case where gas does not leak from the crimped portions despite swelling of the cell, the cell will burst due to the increase in cell inner pressure (problem of battery burst).

Problem 2: When a button-type alkaline battery that uses a cathode mix containing manganese dioxide (MnO₂) as a main component and a button-type alkaline battery that uses a cathode mix containing silver oxide (Ag₂O) mixed with manganese dioxide (MnO₂) to reduce cost are left partially used or completely discharged, deterioration of leakage resistance and battery burst may occur. Even with a button-type alkaline battery that uses a cathode mix containing silver oxide (Ag₂O) that has a hydrogen gas-reducing function mixed with manganese dioxide, leaving the battery partially used or completely discharged will cause deterioration of leakage resistance and battery burst when hydrogen gas is rapidly generated from the anode mix or anode current collector. This is because once the discharge from silver oxide (Ag₂O) having the hydrogen gas-reducing effect is finished, hydrogen gas will not be sufficiently reduced.

Problem 3: In a button-type alkaline battery, the cathode mix containing manganese dioxide (MnO₂) as a main component has a low electrical conductivity and a carbon-based conductive aid such as graphite is preferably added to the cathode mix. However, it is difficult to increase the maximum capacity of the cell since the capacity is decreased by an amount corresponding to the volume of the conductive aid added.

Problem 4: In order for a button-type alkaline battery that uses a cathode mix mainly composed of silver oxide (Ag₂O) or manganese dioxide to achieve a high volume energy density and high electrical conductivity, silver nickelite (AgNiO₂) is added. However, when silver nickelite (AgNiO₂), is used as the depth of discharge increases, the voltage characteristics may deteriorate due to a decreased electrical conductivity caused by generation of Ni(OH)₂ having a low electrical conductivity. In addition, the efficiency of using the cathode active material decreases with the electrical conductivity.

Problem 5: In a button-type alkaline battery that uses a cathode mix containing manganese dioxide, the volume of the cathode increases by discharge, and this contributes to pressing the separator against the gasket. Once the inner pressure in the cell increases by generation of hydrogen gas, the separator is more strongly pressed against the gasket, resulting in cleavage of the separator and causing internal shorts. There is also a problem that the device that uses the battery will be damaged by an increased cell height caused by swelling of the cell.

Problem 6: When button-type alkaline batteries are misused, such as when three are connected in series with one connected in reverse or when four are connected in series with one connected in reverse, the one battery connected in reverse will produce gas due to the charging reaction of the active material. As a result of gas generation, the inner pressure in the cell increases and deterioration of leakage resistance and battery burst occur.

Problem 7: Since the amount of hydrogen gas generated increases by not using mercury, the problems 1 to 6 described above are particularly severe in mercury-free button-type alkaline batteries.

A separator 5 is disposed on the cathode mix 1. The separator 5 has, for example, a three-layer structure constituted by a film obtained by graft-polymerization of a nonwoven cloth, cellophane, and polyethylene. The separator 5 is impregnated with an alkaline electrolyte. Examples of the alkaline electrolyte include an aqueous sodium hydroxide solution and an aqueous potassium hydroxide solution.

A nylon gasket 6 having a ring shape and an L-shaped cross-section is disposed at the inner periphery of the opening end of the cathode can 2. Instead of the gasket 6 having a ring shape and an L-shaped cross-section, a gasket having a ring shape and a J-shaped cross-section may be used such that the tip of the gasket in the anode cup 4 is in contact with the inner surface of the stepped portion of the anode cup 4 to thereby prevent the alkaline electrolyte from contacting the portion of inner surface of the anode cup 4 where no coating layer is formed.

An anode mix 3 is disposed on the separator 5. The anode mix 3 is gel type and may be composed of mercury-free granulated zinc or a mercury-free granulated zinc alloy, an alkaline electrolyte, and a thickener, for example. For example, zinc (Zn) alloyed with bismuth (Bi), indium (In), and/or aluminum (Al) is preferably used as the granulated zinc alloy. In particular, a zinc alloy power composed of a bismuth (Bi)-zinc (Zn) alloy, a bismuth (Bi)-indium (In)-zinc (Zn) alloy, or a bismuth (Bi)-indium (In)-aluminum (Al)-zinc (Zn) alloy may be used as the granulated zinc alloy.

The anode cup 4 is inserted into the open end of the cathode can 2 to house the anode mix 3. The open end of the anode cup 4 is formed as a U-shaped turnup portion 14 folded along the external peripheral surface to have a U-shaped cross-section. The U-shaped turnup portion 14 is clamped by the inner peripheral surface of the open end of the cathode can 2 through the gasket 6 to provide hermetical seal. The anode cup 4 functions as an anode terminal and an anode current collector.

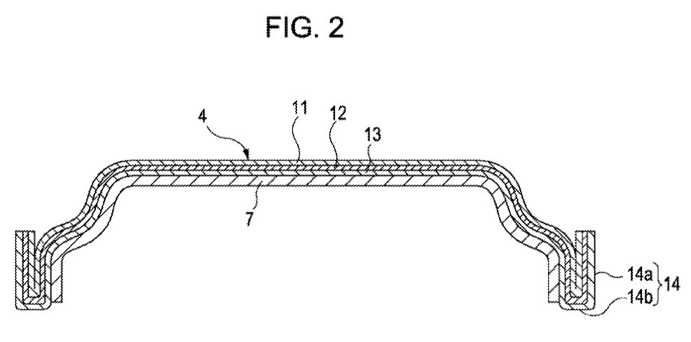

As shown in FIG. 2, the anode cup 4 is produced by pressing a plate constituted by a three-layer clad plate and a coating layer 7 coating the three-layer clad plate into a cup having a stepped portion. During pressing, the coating layer 7 is arranged to come at the inner side.

The three-layer clad plate includes a nickel layer 11, a stainless steel layer 12, and a copper current collector layer 13. The coating layer 7 is formed by, for example, plating the surface of the current collector 13 positioned at the inner side of the anode cup 4 with a metal having a hydrogen overvoltage higher than that of copper. Examples of the metal having a hydrogen overvoltage higher than that of copper include tin, indium, and bismuth. The coating layer 7 may be formed by vapor deposition or by sputtering instead of plating.

The coating layer 7 may be formed by first pressing the three-layer clad material into a cup with the current collector 13 facing inward and then dropping an electroless plating solution of a coating metal into the cup to conduct flow-casting. Alternatively, the coating layer 7 may be formed by vapor deposition, sputtering, or the like after the three-layer clad material is pressed into a cup.

The coating layer 7 coats a limited region of the inner surface of the anode cup 4 from which a bottom 14b and an outer turnup portion 14a of the U-shaped turnup portion 14 of the anode cup 4 are excluded. For example, the coating layer 7 can be formed on the limited region of the inner surface of the anode cup 4 by removing or separating unneeded portions by etching after forming the coating layer 7 over the entirety of the current collector 13. Alternatively, the coating layer 7 may be formed on the limited region of the inner surface of the anode cup 4 by sputtering, vapor-deposition, or the like through a mask.

The button-type alkaline battery according to this embodiment described above has improved leakage resistance since the silver-cobalt-nickel compound oxide represented by formula (1) is added to the cathode mix. Changes in dimensions can also be suppressed. The graphite, silver, nickelite (AgNiO₂), and the like that serve as conductive aids for the cathode mix can be reduced. The current characteristic at the final stage of discharge can be improved. The volume energy density of the cathode mix can be improved. The internal shorts caused by swelling of the battery can be prevented. The safety can be improved despite the increase in amount of hydrogen gas caused by not using mercury in the battery. In the misuse test where the battery is loaded in reverse, such as when three are connected in series with one connected in reverse or when four are connected in series with one connected in reverse, the battery can be prevented from bursting.

A button-type alkaline battery according to another embodiment will now be described. According to this embodiment, amalgamated zinc or an amalgamated granulated zinc alloy is used instead of the mercury-free granulated zinc or mercury-free granulated zinc alloy. In this embodiment, the anode cup 4 of the button-type alkaline battery need not be provided with the coating layer 7 provided in the preceding embodiment. In other words, the coating layer 7 can be omitted. Other structures are substantially the same as those of the button-type alkaline battery of the preceding embodiment and the detailed description therefor is omitted. The button-type alkaline battery of this embodiment achieves the same advantages and effects as the button-type alkaline battery of the preceding embodiment.

### EXAMPLES

The present application is described in detail below with reference to examples according to an embodiment. However, the present application is not limited to these examples.

### Test Examples

As described in Japanese Unexamined Patent Application Publication No. 2002-93427, silver nickelite (AgNiO₂), which has been proposed as a cathode active substance of a button-type alkaline battery, has highly favorable characteristics. However, silver nickelite does not sufficiently address the problems of the related art (e.g., Problems 1 to 7 described above). As for Problems 1 to 7, the characteristics desired for the cathode active material of a button-type alkaline battery compared with silver nickelite (AgNiO₂) involve the following Items 1 to 5:

Item 1: Presence of a substance having a hydrogen gas-reducing property higher than that of silver nickelite (AgNiO₂)

Item 2: Presence of a substance that has a higher hydrogen gas-reducing property than silver nickelite (AgNiO₂) and lasts until the final stage of discharge

Item 3: Presence of a substance that has an electrical conductivity and an electrical capacity close to those of graphite than silver nickelite (AgNiO₂)

Item 4: Presence of a cathode active material exhibiting a higher conductive characteristic than silver nickelite (AgNiO₂) at the final stage of discharge

Item 5: Presence of a substance that has a higher hydrogen gas-reducing property than silver nickelite (AgNiO₂), lasts until the final stage of discharge, and exhibits smaller cubic expansion

In view of the above-described items, a cathode active material of a button-type alkaline battery preferably has (1) hydrogen gas reactivity, (2) electrical conductivity, (3) mass energy density, (4) volume change during discharge superior to those of silver nickelite (AgNiO₂) in order to sufficiently satisfy the desired characteristics. The following tests were conducted on the silver-cobalt-nickel compound oxide represented by formula (1) to investigate (1) hydrogen gas reactivity, (2) electrical conductivity, (3) mass energy density, (4) volume change during discharge. The silver-cobalt-nickel compound oxide represented by formula (1) used in the test examples below was produced as follows.

Synthesis of Silver-Cobalt-Nickel Compound Oxide

To 200 cc of a 2 mol/l aqueous sodium hypochlorite solution, 500 cc of a 10 mol/l aqueous potassium hydroxide solution was added. To the resulting mixture, a 2 mol/l aqueous nickel sulfate solution was added and the resulting mixture was thoroughly stirred.

To 200 cc of a 2 mol/l aqueous sodium hypochlorite solution, 500 cc of a 10 mol/l aqueous potassium hydroxide solution was added. To the resulting mixture, a 2 mol/l aqueous cobalt sulfate solution was added and the resulting mixture was thoroughly stirred.

Nickel oxyhydroxide and cobalt oxyhydroxide obtained as precipitates from the respective mixtures were thoroughly washed with pure water, filtered, dried in a thermostat vessel at 60° C. for 20 hours, pulverized, and passed through a mesh to obtain a nickel oxyhydroxide powder and a cobalt oxyhydroxide powder.

Subsequently, the nickel oxyhydroxide powder and the cobalt oxyhydroxide powder were weighed in accordance with a target Co/Ni ratio and added to an aqueous potassium hydroxide solution. To the resulting mixture, a 1 mol/l aqueous silver nitrate solution was added under vigorous stirring, and the resulting mixture was stirred at 60° C. for 16 hours. After the stirring, the precipitates were filtered, washed with pure water, and dried to obtain a silver-cobalt-nickel compound oxide represented by formula (1).

(1) Reactivity to Hydrogen Gas

### Test Example 1-1

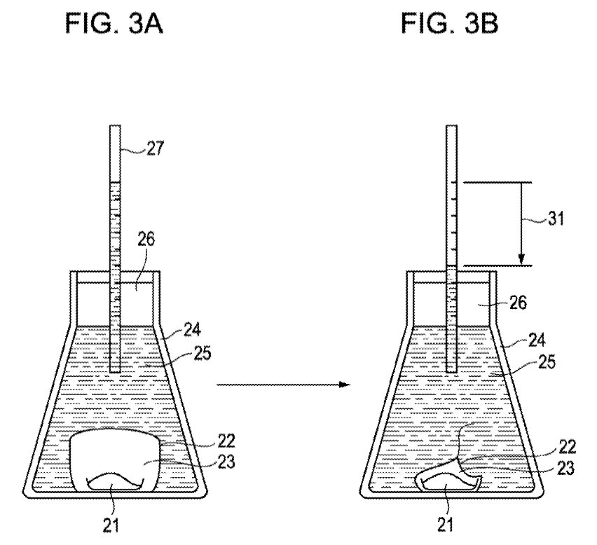

The following hydrogen gas absorption test was conducted to study the reactivity of the silver-cobalt-nickel compound oxide represented by formula (1) to hydrogen gas. The hydrogen gas absorption test is described below with reference to FIGS. 3A and 3B. FIG. 3A shows the initial state of testing, and FIG. 3B shows the state after testing.

As shown in FIG. 3A, 0.1 g of a sample (MnO₂) 21 and 100 ml of hydrogen gas 23 were sealed in an aluminum laminate bag 22 laminated with an aluminum foil. The aluminum laminate bag 22 was placed in a container 24, and the container 24 was filled with a liquid paraffin 25 and hermetically sealed with a lid 26. During this process, a meter run 27 was inserted from the lid 26 and was also filled with the liquid paraffin 25. This state was assumed to be the test initial state. The sample in this state was left to stand at 60° C. As shown in FIG. 3B, the change in volume of the aluminum laminate bag 22 caused by absorption of the hydrogen gas by the sample 21 was measured as the decrease in amount of the liquid paraffin 25 in the meter run 27 (gas absorption amount 31). The gas absorption amount 31 was measured hourly until there was no change in the liquid paraffin level.

### Test Example 1-2

Ag₂O was used as a sample, and the amount of hydrogen gas absorbed by Ag₂O was measured as in Test Example 1-1.

### Test Example 1-3

AgNiO₂ was used as a sample, and the amount of hydrogen gas absorbed by AgNiO₂ was measured as in Test Example 1-1.

### Test Example 1-4

AgCo_{0.10}Ni_{0.90}O₂ was used as a sample, and the amount of hydrogen gas absorbed by AgCo_{0.10}Ni_{0.90}O₂ was measured as in Test Example 1-1.

### Test Example 1-5

AgCo_{0.25}Ni_{0.75}O₂ was used as a sample, and the amount of hydrogen gas absorbed by AgCo_{0.25}Ni_{0.75}O₂ was measured as in Test Example 1-1.

### Test Example 1-6

AgCo_{0.50}Ni_{0.50}O₂ was used as a sample, and the amount of hydrogen gas absorbed by AgCo_{0.50}Ni_{0.50}O₂ was measured as in Test Example 1-1.

### Test Example 1-7

AgCuO₂ was used as a sample, and the amount of hydrogen gas absorbed by AgCuO₂ was measured as in Test Example 1-1.

The measurement results of Test Examples 1-1 to 1-7 are shown in Table 1. The figures shown in Table 1 are figures converted by setting the result of AgNiO₂ to be 100.

TABLE 1

| | | Absorption rate | Total amount of |
|---|---|---|---|
| | Material | (per hour) | absorption |
| Test Example 1-1 | MnO₂ | 0.2 | 0.1 |
| Test Example 1-2 | Ag₂O | 12 | 87 |
| Test Example 1-3 | AgNiO₂ | 100 | 100 |
| Test Example 1-4 | AgCo_{0.10}Ni_{0.90}O₂ | 142 | 108 |
| Test Example 1-5 | AgCo_{0.25}Ni_{0.75}O₂ | 153 | 150 |
| Test Example 1-6 | AgCo_{0.50}Ni_{0.50}O₂ | 241 | 288 |
| Test Example 1-7 | AgCuO₂ | 0.2 | 1 |

As shown in Table 1, in comparison with Test Examples 1-1 to 1-3 and 1-7, Test Examples 1-4 to 1-6 showed a larger hydrogen absorption rate and a larger total absorption amount. In other words, it was found that the silver-cobalt-nickel compound oxide represented by formula (1) had excellent hydrogen gas absorbing performance and a high hydrogen gas absorption rate.

The following was also found from the test results. As disclosed in Japanese Unexamined Patent Application Publication No. 2002-93427, it has been known that, usually, silver oxide (Ag₂O) and silver nickelite (AgNiO₂) are reactive to hydrogen gas and that, in comparison with silver oxide (Ag₂O), silver nickelite (AgNiO₂) can react with a large amount of hydrogen gas in a short time. However, the comparison between Test Example 1-2 and Test Example 1-3 reveals that the total amount of hydrogen gas that can be absorbed by silver nickelite (AgNiO₂) itself is only about 10% higher than that can be absorbed by silver oxide (Ag₂O).

The results of the hydrogen gas absorption test on the silver-cobalt-nickel compound oxide represented by formula (1) in Test Examples 1-4 to 1-6 show that the absorption rate and the total absorption amount increase significantly with the increase in the Co content.

(2) Examination of Electrical Conductivity

### Test Example 2-1

A button-type alkaline battery shown in FIGS. 1 and 2 was produced as follows.

First, as shown in FIG. 2, a three-layer clad plate 0.2 mm in thickness including a nickel layer 11, a stainless steel layer 12, and a copper current collector layer 13 was prepared. A circular tin coating layer 7 0.15 μm in thickness was formed by electroless plating on a limited region of the clad plate.

The clad plate was punch-pressed to form an anode cup 4 having a U-shaped turnup portion 14 at the periphery and an inner surface coated with the tin coating layer 7 except for an outer turnup portion 14a and a bottom 14b.

Graphite (97 percent by weight) was mixed with a fluorocarbon resin, PTFE (3 percent by weight) to obtain a cathode mix 1. The cathode mix 1 was formed into a disk-shaped pellet, inserted in a cathode can 2 containing an aqueous sodium hydroxide solution, and allowed to absorb the aqueous sodium hydroxide solution.

Next, a circular separator 5 formed by punching a three-layer film formed by graft-polymerization of a nonwoven cloth, cellophane, and polyethylene was placed on the cathode mix 1, and a gel-type anode mix 3 containing a granulated zinc alloy (powder of zinc alloyed with aluminum, indium, and bismuth), a thickener, and an aqueous sodium hydroxide solution was placed on the separator 5.

The anode cup 4 was inserted into the open end of the cathode can 2 with a ring-shaped nylon gasket 6 having an L-shaped cross-section between the anode cup 4 and the cathode can 2 to cover the anode mix 3 and provide hermetic seal by crimping. As a result, the button-type alkaline battery shown in FIG. 1 was obtained.

The state of the resulting button-type alkaline battery before discharge was assumed to be the initial state. The current-voltage characteristic in the initial state was measured with a static characteristic meter to determine the initial electrical conductivity.

The button-type alkaline battery was discharged in a discharge capacity meter under a 30 kΩ load resistance until 80% of the battery capacity was discharged, and the current-voltage characteristic of the battery in this discharge final state was measured with a static characteristic meter to determine the electrical conductivity at the discharge final stage. In Test Example 2-1, the capacity of the battery using graphite was assumed to be equal to that of the battery using AgNiO₂, and the state of a battery installed in the discharge capacity meter for the same length of the time under the same discharging conditions as the AgNiO₂ battery was assumed to be the state at which 80% of the battery capacity was discharged.

### Test Example 2-2

AgNiO₂ (97 percent by weight) was mixed with a fluorocarbon resin, PTFE (3 percent by weight) to obtain a cathode mix. A button-type alkaline battery was prepared as in Test Example 2-1 but with this cathode mix, and the electrical conductivity at the initial stage and the discharge final stage was measured.

### Test Example 2-3

AgCo_{0.10}Ni_{0.90}O₂ (97 percent by weight) was mixed with a fluorocarbon resin, PTFE (3 percent by weight) to obtain a cathode mix. A button-type alkaline battery was prepared as in Test Example 2-1 but with this cathode mix, and the electrical conductivity at the initial stage and the discharge final stage was measured.

### Test Example 2-4

AgCo_{0.25}Ni_{0.75}O₂ (97 percent by weight) was mixed with a fluorocarbon resin, PTFE (3 percent by weight) to obtain a cathode mix. A button-type alkaline battery was prepared as in Test Example 2-1 but with this cathode mix, and the electrical conductivity at the initial stage and the discharge final stage was measured.

### Test Example 2-5

AgCo_{0.50}Ni_{0.50}O₂ (97 percent by weight) was mixed with a fluorocarbon resin, PTFE (3 percent by weight) to obtain a cathode mix. A button-type alkaline battery was prepared as in Test Example 2-1 but with this cathode mix, and the electrical conductivity at the initial stage and the discharge final stage was measured.

### Test Example 2-6

AgCuO₂ (97 percent by weight) was mixed with a fluorocarbon resin, PTFE (3 percent by weight) to obtain a cathode mix. A button-type alkaline battery was prepared as in Test Example 2-1 but with this cathode mix, and the electrical conductivity at the initial stage and the discharge final stage was measured.

The measurement results of Test Examples 2-1 to 2-6 are shown in Table 2. The figures of the electrical conductivity shown in Table 2 are figures converted by setting the electrical conductivity of the battery using graphite to be 100.

TABLE 2

| | Material | Initial | After 80% discharge |
|---|---|---|---|
| Test Example 2-1 | Graphite | 100 | 100 |
| Test Example 2-2 | AgNiO₂ | 70 | 50 |
| Test Example 2-3 | AgCo_{0.10}Ni_{0.90}O₂ | 85 | 85 |
| Test Example 2-4 | AgCo_{0.25}Ni_{0.75}O₂ | 90 | 90 |
| Test Example 2-5 | AgCo_{0.50}Ni_{0.50}O₂ | 95 | 95 |
| Test Example 2-6 | AgCuO₂ | 80 | 40 |

As shown in Table 2, in comparison with Test Examples 2-2 and 2-6, Test Examples 2-3 to 2-5 exhibited a high initial electrical conductivity and a high electrical conductivity at the discharge final stage. In other words, it was found that the silver-cobalt-nickel compound oxide represented by formula (1) exhibited a higher electrical conductivity than silver nickelite (AgNiO₂). It was also found that although the electrical conductivities of silver nickelite (AgNiO₂) and AgCuO₂ decreased at the discharge final stage, the silver-cobalt-nickel compound oxide represented by formula (1) showed no decrease in electrical conductivity even at the discharge final stage and thus had a high electrical conductivity.

The electrical conductivity of the silver nickelite (AgNiO₂) of Test Example 2-2 is 70 when the electrical conductivity of graphite is assumed to be 100. The silver nickelite (AgNiO₂) has the same electrical capacity as silver oxide (Ag₂O). Japanese Patent Nos. 3505823 and 3505824 disclose that the amount of graphite used as the conductive aid can be reduced and the battery capacity can be improved by adding silver nickelite (AgNiO₂) having such properties.

The silver-cobalt-nickel compound oxide represented by formula (1) has an electrical conductivity higher than that of silver nickelite (AgNiO₂) and thus can contribute to further reducing the amount of graphite used as the conductive aid. A sufficient electrical conductivity can be achieved even without addition of graphite. Thus, addition of the silver-cobalt-nickel compound oxide represented by formula (1) can further improve the battery capacity.

The electrical conductivity of the silver-cobalt-nickel compound oxide represented by formula (1) at the discharge final stage improved compared to that of silver nickelite (AgNiO₂). The reason that the silver-cobalt-nickel compound oxide represented by formula (1) exhibits a high electrical conductivity at the discharge final stage is presumably as follows.

Usually the reaction of AgNiO₂ proceeds as shown in reaction formula (1) below by discharge reaction. The product, Ni(OH)₂ of the reaction represented by reaction formula (1) has a low electrical conductivity and the electrical conductivity decreases at the discharge final stage.

AgNiO₂+2H₂O+2e⁻→Ag+Ni(OH)₂+20H⁻ Reaction formula (1)

In contrast, the reaction of the silver-cobalt-nickel compound oxide represented by formula (1) proceeds as shown in reaction formula (2) below by discharge reaction:

AgₓCo_{y}Ni_{z}O₂+2H₂O+2xe⁻ [symbol] xAg+yCo(OH)₂+zNi(OH)₂+2xOH⁻ Reaction formula (2)

It is contemplated that the product, Co(OH)₂ of the reaction represented by reaction formula (2) can prevent the electrical conductivity at the discharge final stage from decreasing since the electrical conductivity Co(OH)₂ is significantly higher than that of Ni(OH)₂. Thus, it can be assumed that, unlike silver nickelite (AgNiO₂), the silver-cobalt-nickel compound oxide represented by formula (1) does not undergo a decrease in electrical conductivity at the discharge final stage.

(3) Examination of Mass Energy Density

### Test Example 3-1

AgNiO₂ (97 percent by weight) was mixed with a fluorocarbon resin, PTFE (3 percent by weight) to obtain a cathode mix. The button-type alkaline battery shown in FIGS. 1 and 2 was produced as in Test Example 2-1 except for the following point.

That is, the button-type alkaline battery was discharged under a 30 kΩ discharge load down to cut-off voltages of 1.4 V, 1.2 V, and 0.9 V. The discharge capacity down to each cut-off voltage was measured.

### Test Example 3-2

AgCo_{0.10}Ni_{0.90}O₂ (97 percent by weight) was mixed with a fluorocarbon resin, PTFE (3 percent by weight) to obtain a cathode mix. A button-type alkaline battery was prepared as in Test Example 3-1 but with this cathode mix.

### Test Example 3-3

AgCo_{0.25}Ni_{0.75}O₂ (97 percent by weight) was mixed with a fluorocarbon resin, PTFE (3 percent by weight) to obtain a cathode mix. A button-type alkaline battery was prepared as in Test Example 3-1 but with this cathode mix.

### Test Example 3-4

AgCo_{0.50}Ni_{0.50}O₂ (97 percent by weight) was mixed with a fluorocarbon resin, PTFE (3 percent by weight) to obtain a cathode mix. A button-type alkaline battery was prepared as in Test Example 3-1 but with this cathode mix.

### Test Example 3-5

AgCuO₂ (97 percent by weight) was mixed with a fluorocarbon resin, PTFE (3 percent by weight) to obtain a cathode mix. A button-type alkaline battery was prepared as in Test Example 3-1 but with this cathode mix.

The measurement results of Test Examples 3-1 to 3-5 are shown in Table 3. The discharge capacities shown in Table 3 are values converted by assuming the discharge capacity of the button-type alkaline battery containing AgNiO₂ of Test Example 3-1 at a cut-off voltage of 0.9 V to be 100.

TABLE 3

| | | Cut-off voltage | | |
|---|---|---|---|---|
| | Material | 1.4 V | 1.2 V | 0.9 V |
| Test Example 3-1 | AgNiO₂ | 90 | 97 | 100 |
| Test Example 3-2 | AgCo_{0.10}Ni_{0.90}O₂ | 51 | 97 | 102 |
| Test Example 3-3 | AgCo_{0.25}Ni_{0.75}O₂ | 23 | 91 | 104 |
| Test Example 3-4 | AgCo_{0.50}Ni_{0.50}O₂ | 18 | 61 | 106 |
| Test Example 3-5 | AgCuO₂ | 88 | 89 | 151 |

As shown in Table 3, the comparison between Test Examples 3-2 to 3-4 and Text Example 3-1 revealed that the silver-cobalt-nickel compound oxide represented by formula (1) achieved a higher mass energy density than silver nickelite (AgNiO₂) of the related art. It was also found that the discharge curve of the silver-cobalt-nickel compound oxide represented by formula (1) showed a potential lower than that of AgNiO₂ when the Co content was increased.

These findings indicate the following. In the case of adding a substance to a cathode mix mainly composed of manganese oxide (MnO₂) or a cathode mix containing silver oxide (Ag₂O) and manganese dioxide (MnO₂) for cost reduction, the substance having a discharge curve with a higher discharge potential is consumed first by forming a mixed potential. Thus, silver nickelite (AgNiO₂) that has been used in the related art hardly remains at the discharge final stage and thus substantially only manganese dioxide (MnO₂) remains in the cathode mix. In contrast, when the silver-cobalt-nickel compound oxide represented by formula (1) having a lower potential than silver nickelite (AgNiO₂) is added as a cathode active material, a large amount of cathode active material can remain down to a large depth of discharge.

In other words, when silver nickelite (AgNiO₂) is used, manganese dioxide (MnO₂) having a low reactivity to hydrogen gas constitutes the majority of the cathode mix at the discharge final stage and thus silver nickelite has a small effect of absorbing the hydrogen gas and preventing swelling. In contrast, when the silver-cobalt-nickel compound oxide represented by formula (1) is used, an effect of suppressing swelling stronger than that achieved by silver nickelite (AgNiO₂) can be expected.

It should be noted that use of the silver-cobalt-nickel compound oxide represented by formula (1) can also contribute to increasing the safety in actual operation of the battery, such as when a partially used battery suffers from unexpected hydrogen gas generation, and to increasing the safety of a mercury-free battery that suffers from an increased amount of hydrogen gas.

(4) Examination of Volume Change During Discharge

### Test Example 4-1

The same button-type alkaline battery as that prepared in Test Example 3-1 was used. The battery was discharged for discharge times corresponding to the depths of discharge of 10%, 30%, 50%, 70%, 90%, 110%, 130%, and 150%, and the amount of change in overall height between before discharge and after discharge was measured.

### Test Example 4-2

The same button-type alkaline battery as that prepared in Test Example 3-2 was used. The battery was discharged for discharge times corresponding to the depths of discharge of 10%, 30%, 50%, 70%, 90%, 110%, 130%, and 150%, and the amount of change in overall height between before discharge and after discharge was measured.

### Test Example 4-3

The same button-type alkaline battery as that prepared in Test Example 3-3 was used. The battery was discharged for discharge times corresponding to the depths of discharge of 10%, 30%, 50%, 70%, 90%, 110%, 130%, and 150%, and the amount of change in overall height between before discharge and after discharge was measured.

### Test Example 4-4

The same button-type alkaline battery as that prepared in Test Example 3-4 was used. The battery was discharged for discharge times corresponding to the depths of discharge of 10%, 30%, 50%, 70%, 90%, 110%, 130%, and 150%, and the amount of change in overall height between before discharge and after discharge was measured.

### Test Example 4-5

The same button-type alkaline battery as that prepared in Test Example 3-5 was used. The battery was discharged for discharge times corresponding to the depths of discharge of 10%, 30%, 50%, 70%, 90%, 110%, 130%, and 150%, and the amount of change in overall height between before discharge and after discharge was measured.

The measurement results of Test Examples 4-1 to 4-5 are shown in Table 4. The figures of the amount of change in overall height indicated in Table 4 are figures converted by assuming the amount of change in overall height observed in Test Example 4-1 to be 100.

TABLE 4

| | | Depth of discharge | | | | | | | |
|---|---|---|---|---|---|---|---|---|---|
| | Material | 10% | 30% | 50% | 70% | 90% | 110% | 130% | 150% |
| Test Example 4-1 | AgNiO₂ | 100 | 100 | 100 | 100 | 100 | 100 | 100 | 100 |
| Test Example 4-2 | AgCo_{0.10}Ni_{0.90}O₂ | 92 | 84 | 88 | 93 | 94 | 90 | 89 | 88 |
| Test Example 4-3 | AgCo_{0.25}Ni_{0.75}O₂ | 90 | 82 | 87 | 91 | 92 | 89 | 87 | 86 |
| Test Example 4-4 | AgCo_{0.50}Ni_{0.50}O₂ | 88 | 80 | 84 | 88 | 90 | 86 | 85 | 84 |
| Test Example 4-5 | AgCuO₂ | 103 | 107 | 107 | 114 | 120 | 125 | 130 | 135 |

As shown in Table 4, the comparison between Test Examples 4-2 to 4-4 and Test Example 4-1 revealed that, at each depth of discharge, the cubical expansion of the button-type alkaline battery that used the silver-cobalt-nickel compound oxide represented by formula (1) was smaller than that of the button-type alkaline battery that used silver nickelite (AgNiO₂). This effect was particularly notable at a depth of discharge of 30% and a depth of discharge of 110% or higher.

Evaluation

The tests described in (1) to (4) above showed that the silver-cobalt-nickel compound oxide represented by formula (1) had characteristics superior to those of silver nickelite (AgNiO₂).

In comparison with silver nickelite (AgNiO₂), AgCuO₂ could achieve an improved initial electrical conductivity, an improved energy density, and a decreased potential; however, AgCuO₂ showed no improvements as to the reactivity to hydrogen gas and cubic expansion during discharge. Moreover, since the reaction of AgCuO₂ is a very strong heterogeneous solid-phase reaction similar to that of silver oxide, its discharge curve is flat with three flat stages, which is significantly different from the discharge curves of existing button-type alkaline batteries. Such a battery may not be suited for general use since the voltage-controlling integrated circuits of appliances that use a battery may need improvements.

Although detailed description is omitted here, AgMnO₂ could not be synthesized since due to its unstable composition. However, when AgₓM_{y}N_{z}O₂ is used as the cathode active material with M and N each representing Ni, Co, Fe, Ti, or Pd, AgₓM_{y}N_{z}O₂ tends to achieve the same effects as AgₓCo_{y}Ni_{z}O₂. However, the choice is limited depending on the desired voltage characteristic of the battery used. Thus, it is considered most suitable to use AgₓCo_{y}Ni_{z}O₂ (x+y+z=2, x≦1.10, y>0) as the cathode active material of a button-type alkaline battery.

The reason for setting the limitation of x≦1.10 in AgₓCo_{y}Ni_{z}O₂ is as follows. When Ag is blended in an amount satisfying x>1.10, the mass energy density can be improved. However, the potential of silver oxide (Ag₂O) appears in the discharge curve at the initial stage. Thus, addition of silver in such an amount to a cathode mix that does not contain silver oxide (Ag₂O) causes the discharge curve to change greatly, and thus it is likely that the integrated circuits of the appliances that use a battery may need improvements. Moreover, if the hydrogen gas absorbing effect is desired, blending silver in an amount that satisfies x>1.10 will widen the high potential region and thus a large amount of cathode active material will be consumed at the initial stage of discharge. As a result, the performance at the discharge final stage may not be sufficient, the reaction rate to the hydrogen gas may be lowered, and thus the safety tends to be degraded.

### EXAMPLES

In order to confirm the effects of the silver-cobalt-nickel compound oxide represented by formula (1), button-type alkaline batteries of Examples and Comparative Examples described below were prepared and how these batteries addressed the problems described above was investigated.

### Example 1-1

In Example 1-1, a button-type alkaline battery shown in FIGS. 1 and 2 was prepared as follows.

First, as shown in FIG. 2, a three-layer clad plate 0.2 mm in thickness including a nickel layer 11, a stainless steel layer 12, and a copper current collector layer 13 was prepared. A circular tin coating layer 7 0.15 μm in thickness was formed by electroless plating on a limited region of the clad plate.

The clad plate was punch-pressed to form an anode cup 4 having a U-shaped turnup portion 14 at the periphery and an inner surface coated with the tin coating layer 7 except for an outer turnup portion 14a and a bottom 14b.

AgCo_{0.10}Ni_{0.90}O₂ was prepared as below. To 200 cc of a 2 mol/l aqueous sodium hypochlorite solution, 500 cc of a 10 mol/l aqueous potassium hydroxide solution was added. To the resulting mixture, a 2 mol/l aqueous nickel sulfate solution was added and the resulting mixture was thoroughly stirred.

To 200 cc of a 2 mol/l aqueous sodium hypochlorite solution, 500 cc of a 10 mol/l aqueous potassium hydroxide solution was added. To the resulting mixture, a 2 mol/l aqueous cobalt sulfate solution was added and the resulting mixture was thoroughly stirred.

Nickel oxyhydroxide and cobalt oxyhydroxide obtained as precipitates from the respective mixtures were thoroughly washed with pure water, filtered, dried in a thermostat vessel at 60° C. for 20 hours, pulverized, and passed through a mesh to obtain a nickel oxyhydroxide powder and a cobalt oxyhydroxide powder.

To 300 cc of a 5 mol/l aqueous potassium hydroxide solution, 9 g of nickel oxyhydroxide and 1 g of cobalt oxyhydroxide were added. To the resulting mixture, 100 cc of a 1 mol/l aqueous silver nitrate solution was added under vigorous stirring, and the resulting mixture was stirred for 16 hours at 60° C. Upon completion of stirring, the precipitates were filtered, washed with pure water, and dried to obtain AgCo_{0.10}Ni_{0.90}O₂.

AgCo_{0.10}Ni_{0.90}O₂ (1.5 percent by weight), Ag₂O (98.0 percent by weight) and PTFE (0.5 percent by weight) were mixed to obtain a cathode mix 1. The cathode mix 1 was formed into a disk-shaped pellet, inserted in a cathode can 2 containing an aqueous sodium hydroxide solution, and allowed to absorb the aqueous sodium hydroxide solution.

Next, a circular separator 5 formed by punching a three-layer film formed by graft-polymerization of a nonwoven cloth, cellophane, and polyethylene was placed on the cathode mix 1, and a gel-type anode mix 3 containing a mercury-free granulated zinc alloy (powder of zinc alloyed with aluminum, indium, and bismuth), a thickener, and an aqueous sodium hydroxide solution was placed on the separator 5.

The anode cup 4 was inserted into the open end of the cathode can 2 with a ring-shaped nylon gasket 6 having an L-shaped cross-section between the anode cup 4 and the cathode can 2 to cover the anode mix 3 and provide hermetic seal by crimping. As a result, a button-type alkaline battery (outer diameter: 6.8 mm, height: 2.6 mm) of Example 1-1 was obtained.

### Example 1-2

A button-type alkaline battery of Example 1-2 was prepared as in Example 1-1 except that the cathode mix 1 was obtained by mixing 3 percent by weight AgCo_{0.10}Ni_{0.90}O₂, 96.5 percent by weight Ag₂O, and 0.5 percent by weight PTFE.

### Example 1-3

A button-type alkaline battery of Example 1-3 was prepared as in Example 1-1 except that the cathode mix 1 was obtained by mixing 5 percent by weight AgCo_{0.10}Ni_{0.90}O₂, 94.5 percent by weight Ag₂O, and 0.5 percent by weight PTFE.

### Example 1-4

A button-type alkaline battery of Example 1-4 was prepared as in Example 1-1 except that the cathode mix 1 was obtained by mixing 10 percent by weight AgCo_{0.10}Ni_{0.90}O₂, 89.5 percent by weight Ag₂O, and 0.5 percent by weight PTFE.

### Example 1-5

A button-type alkaline battery of Example 1-5 was prepared as in Example 1-1 except that the cathode mix 1 was obtained by mixing 20 percent by weight AgCo_{0.10}Ni_{0.90}O₂, 79.5 percent by weight Ag₂O, and 0.5 percent by weight PTFE.

### Example 1-6

A button-type alkaline battery of Example 1-6 was prepared as in Example 1-1 except that the cathode mix 1 was obtained by mixing 40 percent by weight AgCo_{0.10}Ni_{0.90}O₂, 59.5 percent by weight Ag₂O, and 0.5 percent by weight PTFE.

### Example 1-7

A button-type alkaline battery of Example 1-7 was prepared as in Example 1-1 except that the cathode mix 1 was obtained by mixing 60 percent by weight AgCo_{0.10}Ni_{0.90}O₂, 39.5 percent by weight Ag₂O, and 0.5 percent by weight PTFE.

### Example 1-8

A button-type alkaline battery of Example 1-8 was prepared as in Example 1-1 except that the cathode mix 1 was obtained by mixing 1 percent by weight AgCo_{0.10}Ni_{0.90}O₂, 98.5 percent by weight Ag₂O, and 0.5 percent by weight PTFE.

### Comparative Example 1-1

A button-type alkaline battery of Comparative Example 1-1 was prepared as in Example 1-1 except that the cathode mix 1 was obtained by mixing 99.5 percent by weight Ag₂O and 0.5 percent by weight PTFE.

### Comparative Example 1-2

A button-type alkaline battery of Comparative Example 1-2 was prepared as in Example 1-1 except that the cathode mix 1 was obtained by mixing 1 percent by weight AgNiO₂, 98.5 percent by weight Ag₂O, and 0.5 percent by weight PTFE.

### Comparative Example 1-3

A button-type alkaline battery of Comparative Example 1-3 was prepared as in Example 1-1 except that the cathode mix 1 was obtained by mixing 1.5 percent by weight AgNiO₂, 98 percent by weight Ag₂O, and 0.5 percent by weight PTFE.

### Comparative Example 1-4

A button-type alkaline battery of Comparative Example 1-4 was prepared as in Example 1-1 except that the cathode mix 1 was obtained by mixing 3 percent by weight AgNiO₂, 96.5 percent by weight Ag₂O, and 0.5 percent by weight PTFE.

### Comparative Example 1-5

A button-type alkaline battery of Comparative Example 1-5 was prepared as in Example 1-1 except that the cathode mix 1 was obtained by mixing 5 percent by weight AgNiO₂, 94.5 percent by weight Ag₂O, and 0.5 percent by weight PTFE.

### Comparative Example 1-6

A button-type alkaline battery of Comparative Example 1-6 was prepared as in Example 1-1 except that the cathode mix 1 was obtained by mixing 10 percent by weight AgNiO₂, 89.5 percent by weight Ag₂O, and 0.5 percent by weight PTFE.

### Comparative Example 1-7

A button-type alkaline battery of Comparative Example 1-7 was prepared as in Example 1-1 except that the cathode mix 1 was obtained by mixing 20 percent by weight AgNiO₂, 79.5 percent by weight Ag₂O, and 0.5 percent by weight PTFE.

### Comparative Example 1-8

A button-type alkaline battery of Comparative Example 1-8 was prepared as in Example 1-1 except that the cathode mix 1 was obtained by mixing 40 percent by weight AgNiO₂, 59.5 percent by weight Ag₂O, and 0.5 percent by weight PTFE.

### Comparative Example 1-9

A button-type alkaline battery of Comparative Example 1-9 was prepared as in Example 1-1 except that the cathode mix 1 was obtained by mixing 60 percent by weight AgNiO₂, 39.5 percent by weight Ag₂O, and 0.5 percent by weight PTFE.

### Comparative Example 1-10

A button-type alkaline battery of Comparative Example 1-10 was prepared as in Example 1-1 except that the cathode mix 1 was obtained by mixing 1 percent by weight AgCuO₂, 98.5 percent by weight Ag₂O, and 0.5 percent by weight PTFE.

### Comparative Example 1-11

A button-type alkaline battery of Comparative Example 1-11 was prepared as in Example 1-1 except that the cathode mix 1 was obtained by mixing 1.5 percent by weight AgCuO₂, 98 percent by weight Ag₂O, and 0.5 percent by weight PTFE.

### Comparative Example 1-12

A button-type alkaline battery of Comparative Example 1-12 was prepared as in Example 1-1 except that the cathode mix 1 was obtained by mixing 3 percent by weight AgCuO₂, 96.5 percent by weight Ag₂O, and 0.5 percent by weight PTFE.

### Comparative Example 1-13

A button-type alkaline battery of Comparative Example 1-13 was prepared as in Example 1-1 except that the cathode mix 1 was obtained by mixing 5 percent by weight AgCuO₂, 94.5 percent by weight Ag₂O, and 0.5 percent by weight PTFE.

### Comparative Example 1-14

A button-type alkaline battery of Comparative Example 1-14 was prepared as in Example 1-1 except that the cathode mix 1 was obtained by mixing 10 percent by weight AgCuO₂, 89.5 percent by weight Ag₂O, and 0.5 percent by weight PTFE.

### Comparative Example 1-15

A button-type alkaline battery of Comparative Example 1-15 was prepared as in Example 1-1 except that the cathode mix 1 was obtained by mixing 20 percent by weight AgCuO₂, 79.5 percent by weight Ag₂O, and 0.5 percent by weight PTFE.

### Comparative Example 1-16

A button-type alkaline battery of Comparative Example 1-16 was prepared as in Example 1-1 except that the cathode mix 1 was obtained by mixing 40 percent by weight AgCuO₂, 59.5 percent by weight Ag₂O, and 0.5 percent by weight PTFE.

### Comparative Example 1-17

A button-type alkaline battery of Comparative Example 1-17 was prepared as in Example 1-1 except that the cathode mix 1 was obtained by mixing 60 percent by weight AgCuO₂, 39.5 percent by weight Ag₂O, and 0.5 percent by weight PTFE.

### Example 2-1

A button-type alkaline battery of Example 2-1 was prepared as in Example 1-1 except that the cathode mix 1 was obtained by mixing 1.5 percent by weight AgCo_{0.10}Ni_{0.90}O₂, 68 percent by weight Ag₂O, 30 percent by weight MnO₂, and 0.5 percent by weight PTFE.

### Example 2-2

A button-type alkaline battery of Example 2-2 was prepared as in Example 2-1 except that the cathode mix 1 was obtained by mixing 3 percent by weight AgCo_{0.10}Ni_{0.90}O₂, 66.5 percent by weight Ag₂O, 30 percent by weight MnO₂, and 0.5 percent by weight PTFE.

### Example 2-3

A button-type alkaline battery of Example 2-3 was prepared as in Example 2-1 except that the cathode mix 1 was obtained by mixing 5 percent by weight AgCo_{0.10}Ni_{0.90}O₂, 64.5 percent by weight Ag₂O, 30 percent by weight MnO₂, and 0.5 percent by weight PTFE.

### Example 2-4

A button-type alkaline battery of Example 2-4 was prepared as in Example 2-1 except that the cathode mix 1 was obtained by mixing 10 percent by weight AgCo_{0.10}Ni_{0.90}O₂, 59.5 percent by weight Ag₂O, 30 percent by weight MnO₂, and 0.5 percent by weight PTFE.

### Example 2-5

A button-type alkaline battery of Example 2-5 was prepared as in Example 2-1 except that the cathode mix 1 was obtained by mixing 20 percent by weight AgCo_{0.10}Ni_{0.90}O₂, 49.5 percent by weight Ag₂O, 30 percent by weight MnO₂, and 0.5 percent by weight PTFE.

### Example 2-6

A button-type alkaline battery of Example 2-6 was prepared as in Example 2-1 except that the cathode mix 1 was obtained by mixing 40 percent by weight AgCo_{0.10}Ni_{0.90}O₂, 29.5 percent by weight Ag₂O, 30 percent by weight MnO₂, and 0.5 percent by weight PTFE.

### Example 2-7

A button-type alkaline battery of Example 2-7 was prepared as in Example 2-1 except that the cathode mix 1 was obtained by mixing 60 percent by weight AgCo_{0.10}Ni_{0.90}O₂, 9.5 percent by weight Ag₂O, 30 percent by weight MnO₂, and 0.5 percent by weight PTFE.

### Example 2-8

A button-type alkaline battery of Example 2-8 was prepared as in Example 2-1 except that the cathode mix 1 was obtained by mixing 1 percent by weight AgCo_{0.10}Ni_{0.90}O₂, 68.5 percent by weight Ag₂O, 30 percent by weight MnO₂, and 0.5 percent by weight PTFE.

### Comparative Example 2-1

A button-type alkaline battery of Comparative Example 2-1 was prepared as in Example 2-1 except that the cathode mix 1 was obtained by mixing 69.5 percent by weight Ag₂O, 30 percent by weight MnO₂, and 0.5 percent by weight PTFE.

### Comparative Example 2-2

A button-type alkaline battery of Comparative Example 2-2 was prepared as in Example 2-1 except that the cathode mix 1 was obtained by mixing 1 percent by weight AgNiO₂, 68.5 percent by weight Ag₂O, 30 percent by weight MnO₂, and 0.5 percent by weight PTFE.

### Comparative Example 2-3

A button-type alkaline battery of Comparative Example 2-3 was prepared as in Example 2-1 except that the cathode mix 1 was obtained by mixing 1.5 percent by weight AgNiO₂, 68 percent by weight Ag₂O, 30 percent by weight MnO₂, and 0.5 percent by weight PTFE.

### Comparative Example 2-4

A button-type alkaline battery of Comparative Example 2-4 was prepared as in Example 2-1 except that the cathode mix 1 was obtained by mixing 3 percent by weight AgNiO₂, 66.5 percent by weight Ag₂O, 30 percent by weight MnO₂, and 0.5 percent by weight PTFE.

### Comparative Example 2-5

A button-type alkaline battery of Comparative Example 2-5 was prepared as in Example 2-1 except that the cathode mix 1 was obtained by mixing 5 percent by weight AgNiO₂, 64.5 percent by weight Ag₂O, 30 percent by weight MnO₂, and 0.5 percent by weight PTFE.

### Comparative Example 2-6

A button-type alkaline battery of Comparative Example 2-6 was prepared as in Example 2-1 except that the cathode mix 1 was obtained by mixing 10 percent by weight AgNiO₂, 59.5 percent by weight Ag₂O, 30 percent by weight MnO₂, and 0.5 percent by weight PTFE.

### Comparative Example 2-7

A button-type alkaline battery of Comparative Example 2-7 was prepared as in Example 2-1 except that the cathode mix 1 was obtained by mixing 20 percent by weight AgNiO₂, 49.5 percent by weight Ag₂O, 30 percent by weight MnO₂, and 0.5 percent by weight PTFE.

### Comparative Example 2-8

A button-type alkaline battery of Comparative Example 2-8 was prepared as in Example 2-1 except that the cathode mix 1 was obtained by mixing 40 percent by weight AgNiO₂, 29.5 percent by weight Ag₂O, 30 percent by weight MnO₂, and 0.5 percent by weight PTFE.

### Comparative Example 2-9

A button-type alkaline battery of Comparative Example 2-9 was prepared as in Example 2-1 except that the cathode mix 1 was obtained by mixing 60 percent by weight AgNiO₂, 9.5 percent by weight Ag₂O, 30 percent by weight MnO₂, and 0.5 percent by weight PTFE.

### Comparative Example 2-10

A button-type alkaline battery of Comparative Example 2-10 was prepared as in Example 2-1 except that the cathode mix 1 was obtained by mixing 1 percent by weight AgCuO₂, 68.5 percent by weight Ag₂O, 30 percent by weight MnO₂, and 0.5 percent by weight PTFE.

### Comparative Example 2-11

A button-type alkaline battery of Comparative Example 2-11 was prepared as in Example 2-1 except that the cathode mix 1 was obtained by mixing 1.5 percent by weight AgCuO₂, 68 percent by weight Ag₂O, 30 percent by weight MnO₂, and 0.5 percent by weight PTFE.

### Comparative Example 2-12

A button-type alkaline battery of Comparative Example 2-12 was prepared as in Example 2-1 except that the cathode mix 1 was obtained by mixing 3 percent by weight AgCuO₂, 66.5 percent by weight Ag₂O, 30 percent by weight MnO₂, and 0.5 percent by weight PTFE.

### Comparative Example 2-13

A button-type alkaline battery of Comparative Example 2-13 was prepared as in Example 2-1 except that the cathode mix 1 was obtained by mixing 5 percent by weight AgCuO₂, 64.5 percent by weight Ag₂O, 30 percent by weight MnO₂, and 0.5 percent by weight PTFE.

### Comparative Example 2-14

A button-type alkaline battery of Comparative Example 2-14 was prepared as in Example 2-1 except that the cathode mix 1 was obtained by mixing 10 percent by weight AgCuO₂, 59.5 percent by weight Ag₂O, 30 percent by weight MnO₂, and 0.5 percent by weight PTFE.

### Comparative Example 2-15

A button-type alkaline battery of Comparative Example 2-15 was prepared as in Example 2-1 except that the cathode mix 1 was obtained by mixing 20 percent by weight AgCuO₂, 49.5 percent by weight Ag₂O, 30 percent by weight MnO₂, and 0.5 percent by weight PTFE.

### Comparative Example 2-16

A button-type alkaline battery of Comparative Example 2-16 was prepared as in Example 2-1 except that the cathode mix 1 was obtained by mixing 40 percent by weight AgCuO₂, 29.5 percent by weight Ag₂O, 30 percent by weight MnO₂, and 0.5 percent by weight PTFE.

### Comparative Example 2-17

A button-type alkaline battery of Comparative Example 2-17 was prepared as in Example 2-1 except that the cathode mix 1 was obtained by mixing 60 percent by weight AgCuO₂, 9.5 percent by weight Ag₂O, 30 percent by weight MnO₂, and 0.5 percent by weight PTFE.

### Example 3-1

A button-type alkaline battery of Example 3-1 was prepared as in Example 1-1 except that the cathode mix 1 was obtained by mixing 1.5 percent by weight AgCo_{0.10}Ni_{0.90}O₂, 98 percent by weight MnO₂, and 0.5 percent by weight PTFE.

### Example 3-2

A button-type alkaline battery of Example 3-2 was prepared as in Example 3-1 except that the cathode mix 3 was obtained by mixing 3 percent by weight AgCo_{0.10}Ni_{0.90}O₂, 96.5 percent by weight MnO₂, and 0.5 percent by weight PTFE.

### Example 3-3

A button-type alkaline battery of Example 3-3 was prepared as in Example 3-1 except that the cathode mix 1 was obtained by mixing 5 percent by weight AgCo_{0.10}Ni_{0.90}O₂, 94.5 percent by weight MnO₂, and 0.5 percent by weight PTFE.

### Example 3-4

A button-type alkaline battery of Example 3-4 was prepared as in Example 3-1 except that the cathode mix 1 was obtained by mixing 10 percent by weight AgCo_{0.10}Ni_{0.90}O₂, 89.5 percent by weight MnO₂, and 0.5 percent by weight PTFE.

### Example 3-5

A button-type alkaline battery of Example 3-5 was prepared as in Example 3-1 except that the cathode mix 1 was obtained by mixing 20 percent by weight AgCo_{0.10}Ni_{0.90}O₂, 79.5 percent by weight MnO₂, and 0.5 percent by weight PTFE.

### Example 3-6

A button-type alkaline battery of Example 3-6 was prepared as in Example 3-1 except that the cathode mix 3 was obtained by mixing 40 percent by weight AgCo_{0.10}Ni_{0.90}O₂, 59.5 percent by weight MnO₂, and 0.5 percent by weight PTFE.

### Example 3-7

A button-type alkaline battery of Example 3-7 was prepared as in Example 3-1 except that the cathode mix 1 was obtained by mixing 60 percent by weight AgCo_{0.10}Ni_{0.90}O₂, 39.5 percent by weight MnO₂, and 0.5 percent by weight PTFE.

### Example 3-8

A button-type alkaline battery of Example 3-8 was prepared as in Example 3-1 except that the cathode mix 1 was obtained by mixing 1 percent by weight AgCo_{0.10}Ni_{0.90}O₂, 98.5 percent by weight MnO₂, and 0.5 percent by weight PTFE.

### Comparative Example 3-1

A button-type alkaline battery of Comparative Example 3-1 was prepared as in Example 3-1 except that the cathode mix 1 was obtained by mixing 99.5 percent by weight MnO₂ and 0.5 percent by weight PTFE.

### Comparative Example 3-2

A button-type alkaline battery of Comparative Example 3-2 was prepared as in Example 3-1 except that the cathode mix 1 was obtained by mixing 1 percent by weight AgNiO₂, 98.5 percent by weight MnO₂, and 0.5 percent by weight PTFE.

### Comparative Example 3-3

A button-type alkaline battery of Comparative Example 3-3 was prepared as in Example 3-1 except that the cathode mix 1 was obtained by mixing 1.5 percent by weight AgNiO₂, 98 percent by weight MnO₂, and 0.5 percent by weight PTFE.

### Comparative Example 3-4

A button-type alkaline battery of Comparative Example 3-4 was prepared as in Example 3-1 except that the cathode mix 1 was obtained by mixing 3 percent by weight AgNiO₂, 96.5 percent by weight MnO₂, and 0.5 percent by weight PTFE.

### Comparative Example 3-5

A button-type alkaline battery of Comparative Example 3-5 was prepared as in Example 3-1 except that the cathode mix 1 was obtained by mixing 5 percent by weight AgNiO₂, 94.5 percent by weight MnO₂, and 0.5 percent by weight PTFE.

### Comparative Example 3-6

A button-type alkaline battery of Comparative Example 3-6 was prepared as in Example 3-1 except that the cathode mix 1 was obtained by mixing 10 percent by weight AgNiO₂, 89.5 percent by weight MnO₂, and 0.5 percent by weight PTFE.

### Comparative Example 3-7

A button-type alkaline battery of Comparative Example 3-7 was prepared as in Example 3-1 except that the cathode mix 1 was obtained by mixing 20 percent by weight AgNiO₂, 79.5 percent by weight MnO₂, and 0.5 percent by weight PTFE.

### Comparative Example 3-8

A button-type alkaline battery of Comparative Example 3-8 was prepared as in Example 3-1 except that the cathode mix 1 was obtained by mixing 40 percent by weight AgNiO₂, 59.5 percent by weight MnO₂, and 0.5 percent by weight PTFE.

### Comparative Example 3-9

A button-type alkaline battery of Comparative Example 3-9 was prepared as in Example 3-1 except that the cathode mix 1 was obtained by mixing 60 percent by weight AgNiO₂, 39.5 percent by weight MnO₂, and 0.5 percent by weight PTFE.

### Comparative Example 3-10

A button-type alkaline battery of Comparative Example 3-10 was prepared as in Example 3-1 except that the cathode mix 1 was obtained by mixing 1 percent by weight AgCuO₂, 98.5 percent by weight MnO₂, and 0.5 percent by weight PTFE.

### Comparative Example 3-11

A button-type alkaline battery of Comparative Example 3-11 was prepared as in Example 3-1 except that the cathode mix 1 was obtained by mixing 1.5 percent by weight AgCuO₂, 98 percent by weight MnO₂, and 0.5 percent by weight PTFE.

### Comparative Example 3-12

A button-type alkaline battery of Comparative Example 3-12 was prepared as in Example 3-1 except that the cathode mix 1 was obtained by mixing 3 percent by weight AgCuO₂, 96.5 percent by weight MnO₂, and 0.5 percent by weight PTFE.

### Comparative Example 3-13

A button-type alkaline battery of Comparative Example 3-13 was prepared as in Example 3-1 except that the cathode mix 1 was obtained by mixing 5 percent by weight AgCuO₂, 94.5 percent by weight MnO₂, and 0.5 percent by weight PTFE.

### Comparative Example 3-14

A button-type alkaline battery of Comparative Example 3-14 was prepared as in Example 3-1 except that the cathode mix 1 was obtained by mixing 10 percent by weight AgCuO₂, 89.5 percent by weight MnO₂, and 0.5 percent by weight PTFE.

### Comparative Example 3-15

A button-type alkaline battery of Comparative Example 3-15 was prepared as in Example 3-1 except that the cathode mix 1 was obtained by mixing 20 percent by weight AgCuO₂, 79.5 percent by weight MnO₂, and 0.5 percent by weight PTFE.

### Comparative Example 3-16

A button-type alkaline battery of Comparative Example 3-16 was prepared as in Example 3-1 except that the cathode mix 1 was obtained by mixing 40 percent by weight AgCuO₂, 59.5 percent by weight MnO₂, and 0.5 percent by weight PTFE.

### Comparative Example 3-17

A button-type alkaline battery of Comparative Example 3-17 was prepared as in Example 3-1 except that the cathode mix 1 was obtained by mixing 60 percent by weight AgCuO₂, 39.5 percent by weight MnO₂, and 0.5 percent by weight PTFE.

The button-type alkaline batteries of Examples 1-1 to 3-8 and Comparative Examples 1-1 to 3-17 were evaluated on the following items.

Leakage Resistance

Twenty samples of button-type alkaline batteries were prepared for each of Examples 1-1 to 3-8 and Comparative Examples 1-1 to 3-17. The button-type alkaline batteries were stored at a temperature of 45° C. and a relative humidity of 93% and the incidence of leakage after 100 days, 120 days, 140 days, and 160 days were investigated. Whether the leakage occurred or not was confirmed with naked eye.

Change in Amount of Swelling when Stored

Five samples of button-type alkaline batteries were prepared for each of Examples 1-1 to 3-8 and Comparative Examples 1-1 to 3-17. The button-type alkaline batteries were stored at a temperature of 60° C. in a dry environment for 100 days and the change in overall height of each battery before and after storage, i.e., ΔHt, was measured.

Voltage Characteristic (CCV Characteristic)

Five samples of button-type alkaline batteries were prepared for each of Examples 1-1 to 3-8 and Comparative Examples 1-1 to 3-17. The minimum voltages at respective depths of discharge (0%, 40%, and 80%) were determined after the button-type alkaline batteries had been discharged for 5 seconds under a 2 kΩ load resistance at −10° C.

Change in Amount of Swelling During Discharge and Change in Overall Height of Partially Used Batteries

In the voltage characteristic (CCV characteristic) test, the overall heights of the batteries at depths of discharge of 30%, 90%, and 110% were measured, and the amount of change, i.e., ΔHt, in overall height with respect to the overall height at 0% depth of discharge was determined. The batteries after discharge were stored for 30 days at 45° C. in a dry environment, and the change, ΔHt, in overall height before and after storage was determined.

Capacity Retention

Five samples of button-type alkaline batteries were prepared for each of Examples 1-1 to 3-8 and Comparative Examples 1-1 to 3-17. The capacity of each button-type alkaline battery was measured before and after 100 days of storage at 60° C. in a dry environment.

Misuse Test

Three samples of button-type alkaline batteries were prepared for each of Examples 1-1 to 3-8 and Comparative Examples 1-1 to 3-17. On the basis of assumption of a typical misuse condition, the button-type alkaline batteries were connected in series to form a closed circuit constituted by three batteries with one connected in reverse, and left connected for 24 hours to investigate whether burst would occur by charging.

Four samples of button-type alkaline batteries were prepared for each of Examples 1-1 to 3-8 and Comparative Examples 1-1 to 3-17. On the basis of assumption of a typical misuse condition, the button-type alkaline batteries were connected in series to form a closed circuit constituted by four batteries with one connected in reverse, and left connected for 24 hours to investigate whether burst would occur by charging. Note that the circuit resistance during this test was set to be not more than 0.1Ω.

Measurement Results of Leakage Resistance

The results showing the leakage resistance of Examples 1-1 to 3-8 and Comparative Examples 1-1 to 3-17 are shown in Table 5. In Table 5, “Co. Example” represents “Comparative Example”.

TABLE 5

| | Cathode mix composition (wt %) | | | | | | Incidence of leakage (%), 45° C./93% RH | | | |
|---|---|---|---|---|---|---|---|---|---|---|
| | AgNiO₂ | AgCo_{0.10}Ni_{0.90}O₂ | AgCuO₂ | Ag₂O | MnO₂ | PTFE | After 100 days | After 120 days | After 140 days | After 160 days |
| Example 1-1 | — | 1.5 | — | 98 | — | 0.5 | 0 | 0 | 0 | 5 |
| Example 1-2 | — | 3 | — | 96.5 | — | 0.5 | 0 | 0 | 0 | 5 |
| Example 1-3 | — | 5 | — | 94.5 | — | 0.5 | 0 | 0 | 0 | 5 |
| Example 1-4 | — | 10 | — | 89.5 | — | 0.5 | 0 | 0 | 0 | 5 |
| Example 1-5 | — | 20 | — | 79.5 | — | 0.5 | 0 | 0 | 0 | 5 |
| Example 1-6 | — | 40 | — | 59.5 | — | 0.5 | 0 | 0 | 0 | 5 |
| Example 1-7 | — | 60 | — | 39.5 | — | 0.5 | 0 | 0 | 0 | 5 |
| Example 1-8 | — | 1 | — | 98.5 | — | 0.5 | 0 | 0 | 0 | 10 |
| Co. Example 1-1 | — | — | — | 99.5 | — | 0.5 | 0 | 0 | 5 | 10 |
| Co. Example 1-2 | 1 | — | — | 98.5 | — | 0.5 | 0 | 0 | 5 | 10 |
| Co. Example 1-3 | 1.5 | — | — | 98 | — | 0.5 | 0 | 0 | 0 | 10 |
| Co. Example 1-4 | 3 | — | — | 96.5 | — | 0.5 | 0 | 0 | 0 | 10 |
| Co. Example 1-5 | 5 | — | — | 94.5 | — | 0.5 | 0 | 0 | 0 | 5 |
| Co. Example 1-6 | 10 | — | — | 89.5 | — | 0.5 | 0 | 0 | 0 | 5 |
| Co. Example 1-7 | 20 | — | — | 79.5 | — | 0.5 | 0 | 0 | 0 | 5 |
| Co. Example 1-8 | 40 | — | — | 59.5 | — | 0.5 | 0 | 0 | 0 | 5 |
| Co. Example 1-9 | 60 | — | — | 39.5 | — | 0.5 | 0 | 0 | 0 | 5 |
| Co. Example 1-10 | — | — | 1 | 98.5 | — | 0.5 | 0 | 5 | 10 | 15 |
| Co. Example 1-11 | — | — | 1.5 | 98 | — | 0.5 | 0 | 0 | 10 | 15 |
| Co. Example 1-12 | — | — | 3 | 96.5 | — | 0.5 | 0 | 0 | 10 | 15 |
| Co. Example 1-13 | — | — | 5 | 94.5 | — | 0.5 | 0 | 0 | 5 | 10 |
| Co. Example 1-14 | — | — | 10 | 89.5 | — | 0.5 | 0 | 0 | 5 | 10 |
| Co. Example 1-15 | — | — | 20 | 79.5 | — | 0.5 | 0 | 0 | 5 | 10 |
| Co. Example 1-16 | — | — | 40 | 59.5 | — | 0.5 | 0 | 0 | 5 | 10 |
| Co. Example 1-17 | — | — | 60 | 39.5 | — | 0.5 | 0 | 0 | 5 | 10 |
| Example 2-1 | — | 1.5 | — | 68 | 30 | 0.5 | 0 | 0 | 0 | 5 |
| Example 2-2 | — | 3 | — | 66.5 | 30 | 0.5 | 0 | 0 | 0 | 5 |
| Example 2-3 | — | 5 | — | 64.5 | 30 | 0.5 | 0 | 0 | 0 | 5 |
| Example 2-4 | — | 10 | — | 59.5 | 30 | 0.5 | 0 | 0 | 0 | 5 |
| Example 2-5 | — | 20 | — | 49.5 | 30 | 0.5 | 0 | 0 | 0 | 5 |
| Example 2-6 | — | 40 | — | 29.5 | 30 | 0.5 | 0 | 0 | 0 | 5 |
| Example 2-7 | — | 60 | — | 9.5 | 30 | 0.5 | 0 | 0 | 0 | 5 |
| Example 2-8 | — | 1 | — | 68.5 | 30 | 0.5 | 0 | 0 | 0 | 10 |
| Co. Example 2-1 | — | — | | 69.5 | 30 | 0.5 | 0 | 0 | 5 | 15 |
| Co. Example 2-2 | 1 | — | | 68.5 | 30 | 0.5 | 0 | 0 | 5 | 15 |
| Co. Example 2-3 | 1.5 | — | | 68 | 30 | 0.5 | 0 | 0 | 0 | 10 |
| Co. Example 2-4 | 3 | — | | 66.5 | 30 | 0.5 | 0 | 0 | 0 | 10 |
| Co. Example 2-5 | 5 | — | | 64.5 | 30 | 0.5 | 0 | 0 | 0 | 5 |
| Co. Example 2-6 | 10 | — | | 59.5 | 30 | 0.5 | 0 | 0 | 0 | 5 |
| Co. Example 2-7 | 20 | — | | 49.5 | 30 | 0.5 | 0 | 0 | 0 | 5 |
| Co. Example 2-8 | 40 | — | | 29.5 | 30 | 0.5 | 0 | 0 | 0 | 5 |
| Co. Example 2-9 | 60 | — | | 9.5 | 30 | 0.5 | 0 | 0 | 0 | 5 |
| Co. Example 2-10 | — | — | 1 | 68.5 | 30 | 0.5 | 0 | 5 | 15 | 20 |
| Co. Example 2-11 | — | — | 1.5 | 68 | 30 | 0.5 | 0 | 0 | 10 | 15 |
| Co. Example 2-12 | — | — | 3 | 66.5 | 30 | 0.5 | 0 | 0 | 10 | 15 |
| Co. Example 2-13 | — | — | 5 | 64.5 | 30 | 0.5 | 0 | 0 | 5 | 10 |
| Co. Example 2-14 | — | — | 10 | 59.5 | 30 | 0.5 | 0 | 0 | 5 | 10 |
| Co. Example 2-15 | — | — | 20 | 49.5 | 30 | 0.5 | 0 | 0 | 5 | 10 |
| Co. Example 2-16 | — | — | 40 | 29.5 | 30 | 0.5 | 0 | 0 | 5 | 10 |
| Co. Example 2-17 | — | — | 60 | 9.5 | 30 | 0.5 | 0 | 0 | 5 | 10 |
| Example 3-1 | — | 1.5 | — | — | 98 | 0.5 | 0 | 0 | 0 | 5 |
| Example 3-2 | — | 3 | — | — | 96.5 | 0.5 | 0 | 0 | 0 | 5 |
| Example 3-3 | — | 5 | — | — | 94.5 | 0.5 | 0 | 0 | 0 | 5 |
| Example 3-4 | — | 10 | — | — | 89.5 | 0.5 | 0 | 0 | 0 | 5 |
| Example 3-5 | — | 20 | — | — | 79.5 | 0.5 | 0 | 0 | 0 | 5 |
| Example 3-6 | — | 40 | — | — | 59.5 | 0.5 | 0 | 0 | 0 | 5 |
| Example 3-7 | — | 60 | — | — | 39.5 | 0.5 | 0 | 0 | 0 | 5 |
| Example 3-8 | — | 1 | — | — | 98.5 | 0.5 | 0 | 0 | 0 | 10 |
| Co. Example 3-1 | — | — | — | — | 99.5 | 0.5 | 0 | 0 | 5 | 20 |
| Co. Example 3-2 | 1 | — | — | — | 98.5 | 0.5 | 0 | 0 | 5 | 20 |
| Co. Example 3-3 | 1.5 | — | — | — | 98 | 0.5 | 0 | 0 | 0 | 15 |
| Co. Example 3-4 | 3 | — | — | — | 96.5 | 0.5 | 0 | 0 | 0 | 15 |
| Co. Example 3-5 | 5 | — | — | — | 94.5 | 0.5 | 0 | 0 | 0 | 5 |
| Co. Example 3-6 | 10 | — | — | — | 89.5 | 0.5 | 0 | 0 | 0 | 5 |
| Co. Example 3-7 | 20 | — | — | — | 79.5 | 0.5 | 0 | 0 | 0 | 5 |
| Co. Example 3-8 | 40 | — | — | — | 59.5 | 0.5 | 0 | 0 | 0 | 5 |
| Co. Example 3-9 | 60 | — | — | — | 39.5 | 0.5 | 0 | 0 | 0 | 5 |
| Co. Example 3-10 | — | — | 1 | — | 98.5 | 0.5 | 0 | 5 | 20 | 25 |
| Co. Example 3-11 | — | — | 1.5 | — | 98 | 0.5 | 0 | 0 | 15 | 20 |
| Co. Example 3-12 | — | — | 3 | — | 96.5 | 0.5 | 0 | 0 | 15 | 20 |
| Co. Example 3-13 | — | — | 5 | — | 94.5 | 0.5 | 0 | 0 | 5 | 10 |
| Co. Example 3-14 | — | — | 10 | — | 89.5 | 0.5 | 0 | 0 | 5 | 10 |
| Co. Example 3-15 | — | — | 20 | — | 79.5 | 0.5 | 0 | 0 | 5 | 10 |
| Co. Example 3-16 | — | — | 40 | — | 59.5 | 0.5 | 0 | 0 | 5 | 10 |
| Co. Example 3-17 | — | — | 60 | — | 39.5 | 0.5 | 0 | 0 | 5 | 10 |

As shown in Table 5, the incidence of leakage after 100 days, 120 days, and 140 days was 0% in Examples 1-1 to 1-8. The incidence of leakage after 160 days was 5% in Examples 1-1 to 1-7. In other words, it was confirmed that Examples 1-1 to 1-8 that used AgCo_{0.10}Ni_{0.90}O₂ exhibited good leakage resistance.

In comparing Examples 1-1 to 1-7 to Example 1-8, the incidence of leakage after 160 days was 5% in Examples 1-1 to 1-7 but the incidence of leakage after 160 days was 10% in Example 1-8. In other words, it was found that when the AgCo_{0.10}Ni_{0.90}O₂ content in the cathode mix was 1.50 percent by weight or more, higher leakage resistance was achieved.

The incidence of leakage after 100 days, 120 days, and 140 days was 0% in Examples 2-1 to 2-8. The incidence of leakage after 160 days was 5% in Examples 2-1 to 2-7. In other words, it was confirmed that Examples 2-1 to 2-8 that used AgCo_{0.10}Ni_{0.90}O₂ exhibited good leakage resistance.

In comparing Examples 2-1 to 2-7 to Example 2-8, the incidence of leakage after 160 days was 5% in Examples 2-1 to 2-7 but the incidence of leakage after 160 days was 10% in Example 2-8. In other words, it was found that when the AgCo_{0.10}Ni_{0.90}O₂ content in the cathode mix was 1.50 percent by weight or more, higher leakage resistance was achieved.

The incidence of leakage after 100 days, 120 days, and 140 days was 0% in Examples 3-1 to 3-8. The incidence of leakage after 160 days was 5% in Examples 3-1 to 3-7. In other words, it was confirmed that Examples 3-1 to 3-8 that used AgCo_{0.10}Ni_{0.90}O₂ exhibited good leakage resistance.

In comparing Examples 3-1 to 3-7 to Example 3-8, the incidence of leakage after 160 days was 5% in Examples 3-1 to 3-7 but the incidence of leakage after 160 days was 10% in Example 3-8. In other words, it was found that when the AgCo_{0.10}Ni_{0.90}O₂ content in the cathode mix was 1.50 percent by weight or more, higher leakage resistance was achieved.

Measurement Results of Change in Amount of Swelling when Stored

The measurement results of change in amount of swelling when stored in Examples 1-1 to 3-8 and Comparative Examples 1-1 to 3-17 are shown in Table 6. In Table 6, “Co. Example” represents “Comparative Example”.

TABLE 6

| | | | | | | | Change in |
|---|---|---|---|---|---|---|---|
| | | | | | | | overall height |
| | | | | | | | when stored |
| | Cathode mix composition (wt %) | | | | | | (mm) |
| | AgNiO₂ | AgCo_{0.10}Ni_{0.90}O₂ | AgCuO₂ | Ag₂O | MnO₂ | PTFE | 60° C., 100 days |
| Example 1-1 | — | 1.5 | — | 98 | — | 0.5 | 0.018 |
| Example 1-2 | — | 3 | — | 96.5 | — | 0.5 | 0.014 |
| Example 1-3 | — | 5 | — | 94.5 | — | 0.5 | 0.010 |
| Example 1-4 | — | 10 | — | 89.5 | — | 0.5 | 0.008 |
| Example 1-5 | — | 20 | — | 79.5 | — | 0.5 | 0.008 |
| Example 1-6 | — | 40 | — | 59.5 | — | 0.5 | 0.007 |
| Example 1-7 | — | 60 | — | 39.5 | — | 0.5 | 0.007 |
| Example 1-8 | — | 1 | — | 98.5 | — | 0.5 | 0.019 |
| Co. Example 1-1 | — | — | — | 99.5 | — | 0.5 | 0.030 |
| Co. Example 1-2 | 1 | — | — | 98.5 | — | 0.5 | 0.027 |
| Co. Example 1-3 | 1.5 | — | — | 98 | — | 0.5 | 0.025 |
| Co. Example 1-4 | 3 | — | — | 96.5 | — | 0.5 | 0.020 |
| Co. Example 1-5 | 5 | — | — | 94.5 | — | 0.5 | 0.014 |
| Co. Example 1-6 | 10 | — | — | 89.5 | — | 0.5 | 0.012 |
| Co. Example 1-7 | 20 | — | — | 79.5 | — | 0.5 | 0.012 |
| Co. Example 1-8 | 40 | — | — | 59.5 | — | 0.5 | 0.010 |
| Co. Example 1-9 | 60 | — | — | 39.5 | — | 0.5 | 0.010 |
| Co. Example 1-10 | — | — | 1 | 98.5 | — | 0.5 | 0.032 |
| Co. Example 1-11 | — | — | 1.5 | 98 | — | 0.5 | 0.030 |
| Co. Example 1-12 | — | — | 3 | 96.5 | — | 0.5 | 0.024 |
| Co. Example 1-13 | — | — | 5 | 94.5 | — | 0.5 | 0.017 |
| Co. Example 1-14 | — | — | 10 | 89.5 | — | 0.5 | 0.014 |
| Co. Example 1-15 | — | — | 20 | 79.5 | — | 0.5 | 0.014 |
| Co. Example 1-16 | — | — | 40 | 59.5 | — | 0.5 | 0.012 |
| Co. Example 1-17 | — | — | 60 | 39.5 | — | 0.5 | 0.012 |
| Example 2-1 | — | 1.5 | — | 68 | 30 | 0.5 | 0.020 |
| Example 2-2 | — | 3 | — | 66.5 | 30 | 0.5 | 0.016 |
| Example 2-3 | — | 5 | — | 64.5 | 30 | 0.5 | 0.011 |
| Example 2-4 | — | 10 | — | 59.5 | 30 | 0.5 | 0.010 |
| Example 2-5 | — | 20 | — | 49.5 | 30 | 0.5 | 0.008 |
| Example 2-6 | — | 40 | — | 29.5 | 30 | 0.5 | 0.007 |
| Example 2-7 | — | 60 | — | 9.5 | 30 | 0.5 | 0.007 |
| Example 2-8 | — | 1 | — | 68.5 | 30 | 0.5 | 0.021 |
| Co. Example 2-1 | — | — | | 69.5 | 30 | 0.5 | 0.033 |
| Co. Example 2-2 | 1 | — | | 68.5 | 30 | 0.5 | 0.030 |
| Co. Example 2-3 | 1.5 | — | | 68 | 30 | 0.5 | 0.028 |
| Co. Example 2-4 | 3 | — | | 66.5 | 30 | 0.5 | 0.023 |
| Co. Example 2-5 | 5 | — | | 64.5 | 30 | 0.5 | 0.017 |
| Co. Example 2-6 | 10 | — | | 59.5 | 30 | 0.5 | 0.015 |
| Co. Example 2-7 | 20 | — | | 49.5 | 30 | 0.5 | 0.013 |
| Co. Example 2-8 | 40 | — | | 29.5 | 30 | 0.5 | 0.010 |
| Co. Example 2-9 | 60 | — | | 9.5 | 30 | 0.5 | 0.010 |
| Co. Example 2-10 | — | — | 1 | 68.5 | 30 | 0.5 | 0.036 |
| Co. Example 2-11 | — | — | 1.5 | 68 | 30 | 0.5 | 0.033 |
| Co. Example 2-12 | — | — | 3 | 66.5 | 30 | 0.5 | 0.027 |
| Co. Example 2-13 | — | — | 5 | 64.5 | 30 | 0.5 | 0.019 |
| Co. Example 2-14 | — | — | 10 | 59.5 | 30 | 0.5 | 0.017 |
| Co. Example 2-15 | — | — | 20 | 49.5 | 30 | 0.5 | 0.014 |
| Co. Example 2-16 | — | — | 40 | 29.5 | 30 | 0.5 | 0.012 |
| Co. Example 2-17 | — | — | 60 | 9.5 | 30 | 0.5 | 0.012 |
| Example 3-1 | — | 1.5 | — | — | 98 | 0.5 | 0.021 |
| Example 3-2 | — | 3 | — | — | 96.5 | 0.5 | 0.017 |
| Example 3-3 | — | 5 | — | — | 94.5 | 0.5 | 0.011 |
| Example 3-4 | — | 10 | — | — | 89.5 | 0.5 | 0.010 |
| Example 3-5 | — | 20 | — | — | 79.5 | 0.5 | 0.008 |
| Example 3-6 | — | 40 | — | — | 59.5 | 0.5 | 0.007 |
| Example 3-7 | — | 60 | — | — | 39.5 | 0.5 | 0.007 |
| Example 3-8 | — | 1 | — | — | 98.5 | 0.5 | 0.022 |
| Co. Example 3-1 | — | — | — | — | 99.5 | 0.5 | 0.036 |
| Co. Example 3-2 | 1 | — | — | — | 98.5 | 0.5 | 0.032 |
| Co. Example 3-3 | 1.5 | — | — | — | 98 | 0.5 | 0.030 |
| Co. Example 3-4 | 3 | — | — | — | 96.5 | 0.5 | 0.024 |
| Co. Example 3-5 | 5 | — | — | — | 94.5 | 0.5 | 0.016 |
| Co. Example 3-6 | 10 | — | — | — | 89.5 | 0.5 | 0.014 |
| Co. Example 3-7 | 20 | — | — | — | 79.5 | 0.5 | 0.012 |
| Co. Example 3-8 | 40 | — | — | — | 59.5 | 0.5 | 0.010 |
| Co. Example 3-9 | 60 | — | — | — | 39.5 | 0.5 | 0.010 |
| Co. Example 3-10 | — | — | 1 | — | 98.5 | 0.5 | 0.038 |
| Co. Example 3-11 | — | — | 1.5 | — | 98 | 0.5 | 0.036 |
| Co. Example 3-12 | — | — | 3 | — | 96.5 | 0.5 | 0.029 |
| Co. Example 3-13 | — | — | 5 | — | 94.5 | 0.5 | 0.019 |
| Co. Example 3-14 | — | — | 10 | — | 89.5 | 0.5 | 0.017 |
| Co. Example 3-15 | — | — | 20 | — | 79.5 | 0.5 | 0.014 |
| Co. Example 3-16 | — | — | 40 | — | 59.5 | 0.5 | 0.012 |
| Co. Example 3-17 | — | — | 60 | — | 39.5 | 0.5 | 0.012 |

As shown in Table 6, in comparing Examples 1-1 to 1-8 with Comparative Example 1-1, the change in overall height that occurs when stored was smaller in Examples 1-1 to 1-8 than in Comparative Example 1-1. In other words, it was found that adding AgCo_{0.10}Ni_{0.90}O₂ to the cathode mix suppressed swelling of the battery.

When Examples 1-1 to 1-8 and Comparative Examples 1-2 to 1-9 in which the same compositional ratio but different components were used were compared, it was found that samples containing AgCo_{0.10}Ni_{0.90}O₂ exhibited amounts of swelling about 30% lower than that exhibited by samples containing silver nickelite (AgNiO₂). Here, the figure “30%” is a figure obtained by assuming the amount of change in overall height of a sample containing silver nickelite (AgNiO₂) to be 100%.

In comparing Examples 2-1 to 2-8 with Comparative Example 2-1, the change in overall height that occurs when stored was smaller in Examples 2-1 to 2-8 than in Comparative Example 2-1. In other words, it was found that adding AgCo_{0.10}Ni_{0.90}O₂ to the cathode mix suppressed swelling of the battery.

When Examples 2-1 to 2-8 and Comparative Examples 2-2 to 2-9 in which the same compositional ratio but different components were used were compared, it was found that samples containing AgCo_{0.10}Ni_{0.90}O₂ exhibited amounts of swelling about 30% lower than that exhibited by samples containing silver nickelite (AgNiO₂).

In comparing Examples 3-1 to 3-8 with Comparative Example 3-1, the change in overall height that occurs when stored was smaller in Examples 3-1 to 3-8 than in Comparative Example 3-1. In other words, it was found that adding AgCo_{0.10}Ni_{0.90}O₂ to the cathode mix suppressed swelling of the battery.

When Examples 3-1 to 3-8 and Comparative Examples 3-2 to 3-9 in which the same compositional ratio but different components were used, were compared, it was found that samples containing AgCo_{0.10}Ni_{0.90}O₂ exhibited amounts of swelling about 30% lower than that exhibited by samples containing silver nickelite (AgNiO₂).

As described above, the measurement results regarding the leakage resistance and the change in amount of swelling that occurs when stored show that samples containing AgCo_{0.10}Ni_{0.90}O₂ exhibit higher performance than samples containing silver nickelite (AgNiO₂). The reason for this is presumably as follows.

The rate of AgCo_{0.10}Ni_{0.90}O₂ of absorbing hydrogen gas generated inside battery from zinc or zinc alloy powder and hydrogen gas generated as a result of contact between zinc or zinc alloy powder and current collector layers through alkaline electrolytes is higher than that achieved by silver nickelite (AgNiO₂). Thus, in samples containing AgCo_{0.10}Ni_{0.90}O₂, the inner pressure of the alkaline battery does not increase easily. This suppresses swelling and allows the battery to remain sealed, resulting in suppression of leakage. AgCuO₂ contained in Comparative Examples has smaller ability to absorb hydrogen gas. Thus, these samples exhibited leakage resistance lower than that of AgCo_{0.10}Ni_{0.90}O₂ and silver nickelite (AgNiO₂).

Since AgCo_{0.10}Ni_{0.90}O₂ has hydrogen gas-absorbing ability, the increase in inner pressure can be prevented also in the case where hydrogen gas is generated when impurities attach to the current collector layers. Thus, swelling and leakage can be avoided, and a highly reliable button-type alkaline battery can be provided.

Measurement Results of Voltage Characteristic (CCV Characteristic)

The measurement results of voltage characteristic of Examples 1-1 to 3-8 and Comparative Examples 1-1 to 3-17 are shown in Table 7. In Table 7, “Co. Example” represents “Comparative Example”

TABLE 7

| | Cathode mix composition (wt %) | | | | | | CCV characteristic (V) | | |
|---|---|---|---|---|---|---|---|---|---|
| | AgNiO₂ | AgCo_{0.10}Ni_{0.90}O₂ | AgCuO₂ | Ag₂O | MnO₂ | PTFE | DOD 0% | DOD 40% | DOD 80% |
| Example 1-1 | — | 1.5 | — | 98 | — | 0.5 | 1.311 | 1.320 | 1.283 |
| Example 1-2 | — | 3 | — | 96.5 | — | 0.5 | 1.323 | 1.365 | 1.298 |
| Example 1-3 | — | 5 | — | 94.5 | — | 0.5 | 1.364 | 1.446 | 1.346 |
| Example 1-4 | — | 10 | — | 89.5 | — | 0.5 | 1.398 | 1.443 | 1.351 |
| Example 1-5 | — | 20 | — | 79.5 | — | 0.5 | 1.428 | 1.443 | 1.354 |
| Example 1-6 | — | 40 | — | 59.5 | — | 0.5 | 1.447 | 1.445 | 1.368 |
| Example 1-7 | — | 60 | — | 39.5 | — | 0.5 | 1.448 | 1.442 | 1.366 |
| Example 1-8 | — | 1 | — | 98.5 | — | 0.5 | 1.290 | 1.243 | 1.186 |
| Co. Example 1-1 | — | — | — | 99.5 | — | 0.5 | 1.210 | 1.207 | 1.086 |
| Co. Example 1-2 | 1 | — | — | 98.5 | — | 0.5 | 1.252 | 1.215 | 1.120 |
| Co. Example 1-3 | 1.5 | — | — | 98 | — | 0.5 | 1.280 | 1.240 | 1.187 |
| Co. Example 1-4 | 3 | — | — | 96.5 | — | 0.5 | 1.303 | 1.282 | 1.253 |
| Co. Example 1-5 | 5 | — | — | 94.5 | — | 0.5 | 1.321 | 1.426 | 1.311 |
| Co. Example 1-6 | 10 | — | — | 89.5 | — | 0.5 | 1.378 | 1.434 | 1.320 |
| Co. Example 1-7 | 20 | — | — | 79.5 | — | 0.5 | 1.385 | 1.442 | 1.342 |
| Co. Example 1-8 | 40 | — | — | 59.5 | — | 0.5 | 1.433 | 1.437 | 1.350 |
| Co. Example 1-9 | 60 | — | — | 39.5 | — | 0.5 | 1.428 | 1.435 | 1.318 |
| Co. Example 1-10 | — | — | 1 | 98.5 | — | 0.5 | 1.202 | 1.033 | 0.952 |
| Co. Example 1-11 | — | — | 1.5 | 98 | — | 0.5 | 1.229 | 1.054 | 1.009 |
| Co. Example 1-12 | — | — | 3 | 96.5 | — | 0.5 | 1.251 | 1.090 | 1.065 |
| Co. Example 1-13 | — | — | 5 | 94.5 | — | 0.5 | 1.268 | 1.212 | 1.114 |
| Co. Example 1-14 | — | — | 10 | 89.5 | — | 0.5 | 1.323 | 1.219 | 1.122 |
| Co. Example 1-15 | — | — | 20 | 79.5 | — | 0.5 | 1.330 | 1.226 | 1.141 |
| Co. Example 1-16 | — | — | 40 | 59.5 | — | 0.5 | 1.376 | 1.221 | 1.148 |
| Co. Example 1-17 | — | — | 60 | 39.5 | — | 0.5 | 1.371 | 1.220 | 1.158 |
| Example 2-1 | — | 1.5 | — | 68 | 30 | 0.5 | 1.334 | 1.322 | 1.285 |
| Example 2-2 | — | 3 | — | 66.5 | 30 | 0.5 | 1.351 | 1.387 | 1.301 |
| Example 2-3 | — | 5 | — | 64.5 | 30 | 0.5 | 1.391 | 1.453 | 1.305 |
| Example 2-4 | — | 10 | — | 59.5 | 30 | 0.5 | 1.412 | 1.438 | 1.318 |
| Example 2-5 | — | 20 | — | 49.5 | 30 | 0.5 | 1.433 | 1.440 | 1.325 |
| Example 2-6 | — | 40 | — | 29.5 | 30 | 0.5 | 1.448 | 1.435 | 1.321 |
| Example 2-7 | — | 60 | — | 9.5 | 30 | 0.5 | 1.444 | 1.437 | 1.320 |
| Example 2-8 | — | 1 | — | 68.5 | 30 | 0.5 | 1.305 | 1.254 | 1.202 |
| Co. Example 2-1 | — | — | | 69.5 | 30 | 0.5 | 0.297 | 1.210 | 1.075 |
| Co. Example 2-2 | 1 | — | | 68.5 | 30 | 0.5 | 1.301 | 1.217 | 1.103 |
| Co. Example 2-3 | 1.5 | — | | 68 | 30 | 0.5 | 1.305 | 1.232 | 1.178 |
| Co. Example 2-4 | 3 | — | | 66.5 | 30 | 0.5 | 1.311 | 1.258 | 1.241 |
| Co. Example 2-5 | 5 | — | | 64.5 | 30 | 0.5 | 1.325 | 1.448 | 1.294 |
| Co. Example 2-6 | 10 | — | | 59.5 | 30 | 0.5 | 1.399 | 1.436 | 1.307 |
| Co. Example 2-7 | 20 | — | | 49.5 | 30 | 0.5 | 1.412 | 1.435 | 1.313 |
| Co. Example 2-8 | 40 | — | | 29.5 | 30 | 0.5 | 1.432 | 1.437 | 1.308 |
| Co. Example 2-9 | 60 | — | | 9.5 | 30 | 0.5 | 1.442 | 1.439 | 1.243 |
| Co. Example 2-10 | — | — | 1 | 68.5 | 30 | 0.5 | 1.249 | 1.034 | 0.938 |
| Co. Example 2-11 | — | — | 1.5 | 68 | 30 | 0.5 | 1.253 | 1.047 | 1.001 |
| Co. Example 2-12 | — | — | 3 | 66.5 | 30 | 0.5 | 1.259 | 1.069 | 1.055 |
| Co. Example 2-13 | — | — | 5 | 64.5 | 30 | 0.5 | 1.272 | 1.231 | 1.100 |
| Co. Example 2-14 | — | — | 10 | 59.5 | 30 | 0.5 | 1.343 | 1.221 | 1.111 |
| Co. Example 2-15 | — | — | 20 | 49.5 | 30 | 0.5 | 1.356 | 1.220 | 1.116 |
| Co. Example 2-16 | — | — | 40 | 29.5 | 30 | 0.5 | 1.375 | 1.221 | 1.112 |
| Co. Example 2-17 | — | — | 60 | 9.5 | 30 | 0.5 | 1.384 | 1.223 | 1.114 |
| Example 3-1 | — | 1.5 | — | — | 98 | 0.5 | 1.402 | 1.284 | 1.196 |
| Example 3-2 | — | 3 | — | — | 96.5 | 0.5 | 1.425 | 1.312 | 1.205 |
| Example 3-3 | — | 5 | — | — | 94.5 | 0.5 | 1.483 | 1.342 | 1.208 |
| Example 3-4 | — | 10 | — | — | 89.5 | 0.5 | 1.479 | 1.348 | 1.204 |
| Example 3-5 | — | 20 | — | — | 79.5 | 0.5 | 1.484 | 1.347 | 1.205 |
| Example 3-6 | — | 40 | — | — | 59.5 | 0.5 | 1.488 | 1.342 | 1.204 |
| Example 3-7 | — | 60 | — | — | 39.5 | 0.5 | 1.483 | 1.345 | 1.206 |
| Example 3-8 | — | 1 | — | — | 98.5 | 0.5 | 1.334 | 1.245 | 1.150 |
| Co. Example 3-1 | — | — | — | — | 99.5 | 0.5 | 1.301 | 1.090 | 1.081 |
| Co. Example 3-2 | 1 | — | — | — | 98.5 | 0.5 | 1.322 | 1.118 | 1.106 |
| Co. Example 3-3 | 1.5 | — | — | — | 98 | 0.5 | 1.381 | 1.194 | 1.113 |
| Co. Example 3-4 | 3 | — | — | — | 96.5 | 0.5 | 1.401 | 1.224 | 1.125 |
| Co. Example 3-5 | 5 | — | — | — | 94.5 | 0.5 | 1.476 | 1.321 | 1.198 |
| Co. Example 3-6 | 10 | — | — | — | 89.5 | 0.5 | 1.477 | 1.331 | 1.202 |
| Co. Example 3-7 | 20 | — | — | — | 79.5 | 0.5 | 1.472 | 1.333 | 1.202 |
| Co. Example 3-8 | 40 | — | — | — | 59.5 | 0.5 | 1.465 | 1.335 | 1.193 |
| Co. Example 3-9 | 60 | — | — | — | 39.5 | 0.5 | 1.471 | 1.332 | 1.153 |
| Co. Example 3-10 | — | — | 1 | — | 98.5 | 0.5 | 1.269 | 0.950 | 0.940 |
| Co. Example 3-11 | — | — | 1.5 | — | 98 | 0.5 | 1.326 | 1.015 | 0.946 |
| Co. Example 3-12 | — | — | 3 | — | 96.5 | 0.5 | 1.345 | 1.040 | 0.956 |
| Co. Example 3-13 | — | — | 5 | — | 94.5 | 0.5 | 1.417 | 1.123 | 1.018 |
| Co. Example 3-14 | — | — | 10 | — | 89.5 | 0.5 | 1.418 | 1.131 | 1.026 |
| Co. Example 3-15 | — | — | 20 | — | 79.5 | 0.5 | 1.413 | 1.133 | 1.022 |
| Co. Example 3-16 | — | — | 40 | — | 59.5 | 0.5 | 1.406 | 1.135 | 1.014 |
| Co. Example 3-17 | — | — | 60 | — | 39.5 | 0.5 | 1.412 | 1.132 | 1.023 |

As shown in Table 7, in comparison with Comparative Example 1-1, Examples 1-1 to 1-8 exhibited good voltage characteristics.

Examples 1-1 to 1-8 and Comparative Examples 1-2 to 1-9 showed that a voltage characteristic comparable to that when 5 percent by weight or more silver nickelite (AgNiO₂) was contained was achieved when 1.5 percent by weight or more of AgCo_{0.10}Ni_{0.90}O₂ was contained.

In Comparative Example 1-9 containing 60 percent by weight of silver nickelite (AgNiO₂), a voltage drop occurred by an increase in resistance component caused by excessive generation of Ni(OH)₂ at 80% depth of discharge. In contrast, voltage drops were not observed in samples containing AgCo_{0.10}Ni_{0.90}O₂ since generation of Co(OH)₂ suppressed a decrease in electrical conductivity. In Comparative Examples 1-10 to 1-17, AgCuO₂ shifts to a potential having no electrical conductivity after the initial flat potential and thus samples of Comparative Examples 1-10 to 1-17 had low potential at a depth of discharge of 40% or more.

Accordingly, it was found that in comparison with Comparative Example 2-1, Examples 2-1 to 2-8 exhibited good voltage characteristics.

Examples 2-1 to 2-8 and Comparative Examples 2-2 to 2-9 showed that a voltage characteristic comparable to that when 5 percent by weight or more silver nickelite (AgNiO₂) was contained was achieved when 1.5 percent by weight or more of AgCo_{0.10}Ni_{0.90}O₂ was contained.

In Comparative Example 2-9 containing 60 percent by weight of AgNiO₂, a voltage drop occurred by an increase in resistance component caused by excessive generation of Ni(OH)₂ at 80% depth of discharge. In contrast, voltage drops were not observed in samples containing AgCo_{0.10}Ni_{0.90}O₂ since generation of Co(OH)₂ suppressed a decrease in electrical conductivity. In Comparative Examples 2-10 to 2-17, AgCuO₂ shifts to a potential having no electrical conductivity after the initial flat potential and thus samples of Comparative Examples 2-10 to 2-17 had low potential at a depth of discharge of 40% or more.

Accordingly, it was found that in comparison with Comparative Example 3-1, Examples 3-1 to 3-8 exhibited good voltage characteristics.

Examples 3-1 to 3-8 and Comparative Examples 3-2 to 3-9 showed that a voltage characteristic comparable to that when 5 percent by weight or more silver nickelite (AgNiO₂) was contained was achieved when 1.5 percent by weight or more of AgCo_{0.10}Ni_{0.90}O₂ was contained.

In Comparative Example 3-9 containing 60 percent by weight of silver nickelite (AgNiO₂), a voltage drop occurred by an increase in resistance component caused by excessive generation of Ni(OH)₂ at 80% depth of discharge. In contrast, voltage drops were not observed in samples containing AgCo_{0.10}Ni_{0.90}O₂ since generation of Co(OH)₂ suppressed a decrease in electrical conductivity. In Comparative Examples 3-10 to 3-17, AgCuO₂ shifts to a potential having no electrical conductivity after the initial flat potential and thus samples of Comparative Examples 3-10 to 3-17 had low potential at a depth of discharge of 40% or more.

Measurement Results of Change in Amount of Swelling During Discharge and Change in Overall Height of Partially Used Batteries

The measurement results of change in amount of swelling during discharge and change in overall height of partially used batteries of Examples 1-1 to 3-8 and Comparative Examples 1-1 to 3-17 are shown in Table 8. In Table 8, “Co. Example” represents “Comparative Example”

TABLE 8

| | | | | | | | Change in overall height | | | Change in overall height of | | |
|---|---|---|---|---|---|---|---|---|---|---|---|---|
| | Cathode mix composition | | | | | | during discharge | | | partially used battery (mm) | | |
| | (wt %) | | | | | | (mm) | | | DOD | DOD | DOD |
| | AgNiO₂ | AgCo_{0.10}Ni_{0.90}O₂ | AgCuO₂ | Ag₂O | MnO₂ | PTFE | DOD 30% | DOD 90% | DOD 110% | 30% | 90% | 110% |
| Example 1-1 | — | 1.5 | — | 98 | — | 0.5 | 0.008 | 0.018 | 0.021 | 0.000 | −0.001 | −0.005 |
| Example 1-2 | — | 3 | — | 96.5 | — | 0.5 | 0.008 | 0.018 | 0.021 | −0.001 | −0.008 | −0.013 |
| Example 1-3 | — | 5 | — | 94.5 | — | 0.5 | 0.008 | 0.018 | 0.021 | −0.001 | −0.008 | −0.013 |
| Example 1-4 | — | 10 | — | 89.5 | — | 0.5 | 0.008 | 0.018 | 0.021 | −0.001 | −0.008 | −0.013 |
| Example 1-5 | — | 20 | — | 79.5 | — | 0.5 | 0.008 | 0.018 | 0.020 | −0.002 | −0.013 | −0.018 |
| Example 1-6 | — | 40 | — | 59.5 | — | 0.5 | 0.007 | 0.017 | 0.020 | −0.003 | −0.016 | −0.021 |
| Example 1-7 | — | 60 | — | 39.5 | — | 0.5 | 0.007 | 0.017 | 0.019 | −0.005 | −0.018 | −0.023 |
| Example 1-8 | — | 1 | — | 98.5 | — | 0.5 | 0.008 | 0.018 | 0.021 | 0.001 | 0.000 | −0.002 |
| Co. Example 1-1 | — | — | — | 99.5 | — | 0.5 | 0.008 | 0.018 | 0.021 | 0.002 | 0.001 | −0.002 |
| Co. Example 1-2 | 1 | — | — | 98.5 | — | 0.5 | 0.008 | 0.018 | 0.021 | 0.001 | 0.000 | −0.002 |
| Co. Example 1-3 | 1.5 | — | — | 98 | — | 0.5 | 0.008 | 0.018 | 0.021 | 0.000 | −0.001 | −0.005 |
| Co. Example 1-4 | 3 | — | — | 96.5 | — | 0.5 | 0.008 | 0.018 | 0.021 | −0.001 | −0.008 | −0.013 |
| Co. Example 1-5 | 5 | — | — | 94.5 | — | 0.5 | 0.008 | 0.018 | 0.021 | −0.001 | −0.008 | −0.013 |
| Co. Example 1-6 | 10 | — | — | 89.5 | — | 0.5 | 0.008 | 0.018 | 0.021 | −0.001 | −0.008 | −0.013 |
| Co. Example 1-7 | 20 | — | — | 79.5 | — | 0.5 | 0.008 | 0.018 | 0.021 | −0.002 | −0.013 | −0.018 |
| Co. Example 1-8 | 40 | — | — | 59.5 | — | 0.5 | 0.008 | 0.018 | 0.021 | −0.003 | −0.016 | −0.021 |
| Co. Example 1-9 | 60 | — | — | 39.5 | — | 0.5 | 0.008 | 0.018 | 0.021 | −0.005 | −0.018 | −0.023 |
| Co. Example 1-10 | — | — | 1 | 98.5 | — | 0.5 | 0.008 | 0.018 | 0.021 | 0.002 | 0.003 | 0.004 |
| Co. Example 1-11 | — | — | 1.5 | 98 | — | 0.5 | 0.008 | 0.018 | 0.021 | 0.002 | 0.003 | 0.004 |
| Co. Example 1-12 | — | — | 3 | 96.5 | — | 0.5 | 0.008 | 0.018 | 0.021 | 0.003 | 0.004 | 0.005 |
| Co. Example 1-13 | — | — | 5 | 94.5 | — | 0.5 | 0.008 | 0.018 | 0.021 | 0.004 | 0.005 | 0.006 |
| Co. Example 1-14 | — | — | 10 | 89.5 | — | 0.5 | 0.008 | 0.018 | 0.022 | 0.006 | 0.007 | 0.009 |
| Co. Example 1-15 | — | — | 20 | 79.5 | — | 0.5 | 0.008 | 0.019 | 0.022 | 0.009 | 0.009 | 0.011 |
| Co. Example 1-16 | — | — | 40 | 59.5 | — | 0.5 | 0.008 | 0.019 | 0.023 | 0.011 | 0.014 | 0.016 |
| Co. Example 1-17 | — | — | 60 | 39.5 | — | 0.5 | 0.008 | 0.020 | 0.024 | 0.014 | 0.016 | 0.018 |
| Example 2-1 | — | 1.5 | — | 68 | 30 | 0.5 | 0.022 | 0.067 | 0.080 | 0.001 | −0.003 | −0.013 |
| Example 2-2 | — | 3 | — | 66.5 | 30 | 0.5 | 0.022 | 0.067 | 0.080 | 0.000 | −0.008 | −0.019 |
| Example 2-3 | — | 5 | — | 64.5 | 30 | 0.5 | 0.022 | 0.067 | 0.079 | −0.001 | −0.011 | −0.021 |
| Example 2-4 | — | 10 | — | 59.5 | 30 | 0.5 | 0.022 | 0.066 | 0.079 | −0.006 | −0.015 | −0.025 |
| Example 2-5 | — | 20 | — | 49.5 | 30 | 0.5 | 0.021 | 0.066 | 0.078 | −0.012 | −0.025 | −0.032 |
| Example 2-6 | — | 40 | — | 29.5 | 30 | 0.5 | 0.020 | 0.064 | 0.076 | −0.018 | −0.034 | −0.038 |
| Example 2-7 | — | 60 | — | 9.5 | 30 | 0.5 | 0.019 | 0.063 | 0.073 | −0.022 | −0.042 | −0.045 |
| Example 2-8 | — | 1 | — | 68.5 | 30 | 0.5 | 0.022 | 0.067 | 0.080 | 0.002 | 0.000 | −0.005 |
| Co. Example 2-1 | — | — | — | 69.5 | 30 | 0.5 | 0.022 | 0.067 | 0.080 | 0.004 | 0.003 | 0.000 |
| Co. Example 2-2 | 1 | — | — | 68.5 | 30 | 0.5 | 0.022 | 0.067 | 0.080 | 0.003 | 0.002 | 0.000 |
| Co. Example 2-3 | 1.5 | — | — | 68 | 30 | 0.5 | 0.022 | 0.067 | 0.080 | 0.002 | 0.001 | −0.003 |
| Co. Example 2-4 | 3 | — | — | 66.5 | 30 | 0.5 | 0.022 | 0.067 | 0.080 | 0.001 | −0.006 | −0.011 |
| Co. Example 2-5 | 5 | — | — | 64.5 | 30 | 0.5 | 0.022 | 0.067 | 0.080 | 0.001 | −0.006 | −0.011 |
| Co. Example 2-6 | 10 | — | — | 59.5 | 30 | 0.5 | 0.022 | 0.067 | 0.080 | 0.001 | −0.006 | −0.011 |
| Co. Example 2-7 | 20 | — | — | 49.5 | 30 | 0.5 | 0.022 | 0.067 | 0.080 | 0.000 | −0.011 | −0.016 |
| Co. Example 2-8 | 40 | — | — | 29.5 | 30 | 0.5 | 0.022 | 0.067 | 0.080 | −0.001 | −0.014 | −0.019 |
| Co. Example 2-9 | 60 | — | — | 9.5 | 30 | 0.5 | 0.022 | 0.067 | 0.080 | −0.003 | −0.016 | −0.021 |
| Co. Example 2-10 | — | — | 1 | 68.5 | 30 | 0.5 | 0.022 | 0.067 | 0.080 | 0.004 | 0.005 | 0.006 |
| Co. Example 2-11 | — | — | 1.5 | 68 | 30 | 0.5 | 0.022 | 0.067 | 0.080 | 0.004 | 0.005 | 0.006 |
| Co. Example 2-12 | — | — | 3 | 66.5 | 30 | 0.5 | 0.022 | 0.067 | 0.081 | 0.005 | 0.006 | 0.007 |
| Co. Example 2-13 | — | — | 5 | 64.5 | 30 | 0.5 | 0.022 | 0.068 | 0.081 | 0.006 | 0.007 | 0.008 |
| Co. Example 2-14 | — | — | 10 | 59.5 | 30 | 0.5 | 0.022 | 0.068 | 0.082 | 0.008 | 0.009 | 0.011 |
| Co. Example 2-15 | — | — | 20 | 49.5 | 30 | 0.5 | 0.022 | 0.070 | 0.084 | 0.011 | 0.011 | 0.013 |
| Co. Example 2-16 | — | — | 40 | 29.5 | 30 | 0.5 | 0.023 | 0.072 | 0.088 | 0.013 | 0.016 | 0.018 |
| Co. Example 2-17 | — | — | 60 | 9.5 | 30 | 0.5 | 0.023 | 0.075 | 0.092 | 0.016 | 0.018 | 0.020 |
| Example 3-1 | — | 1.5 | — | — | 98 | 0.5 | 0.042 | 0.125 | 0.150 | 0.004 | −0.002 | −0.010 |
| Example 3-2 | — | 3 | — | — | 96.5 | 0.5 | 0.042 | 0.125 | 0.149 | 0.003 | −0.006 | −0.014 |
| Example 3-3 | — | 5 | — | — | 94.5 | 0.5 | 0.041 | 0.124 | 0.149 | 0.002 | −0.008 | −0.016 |
| Example 3-4 | — | 10 | — | — | 89.5 | 0.5 | 0.041 | 0.124 | 0.148 | −0.004 | −0.010 | −0.017 |
| Example 3-5 | — | 20 | — | — | 79.5 | 0.5 | 0.039 | 0.123 | 0.146 | −0.008 | −0.016 | −0.018 |
| Example 3-6 | — | 40 | — | — | 59.5 | 0.5 | 0.036 | 0.120 | 0.142 | −0.012 | −0.020 | −0.022 |
| Example 3-7 | — | 60 | — | — | 39.5 | 0.5 | 0.033 | 0.118 | 0.137 | −0.016 | −0.024 | −0.026 |
| Example 3-8 | — | 1 | — | — | 98.5 | 0.5 | 0.042 | 0.125 | 0.150 | 0.006 | 0.002 | −0.004 |
| Co. Example 3-1 | — | — | — | — | 99.5 | 0.5 | 0.042 | 0.125 | 0.150 | 0.012 | 0.007 | 0.003 |
| Co. Example 3-2 | 1 | — | — | — | 98.5 | 0.5 | 0.042 | 0.125 | 0.150 | 0.010 | 0.006 | 0.022 |
| Co. Example 3-3 | 1.5 | — | — | — | 98 | 0.5 | 0.042 | 0.125 | 0.150 | 0.006 | 0.002 | −0.002 |
| Co. Example 3-4 | 3 | — | — | — | 96.5 | 0.5 | 0.042 | 0.125 | 0.150 | 0.004 | −0.004 | −0.008 |
| Co. Example 3-5 | 5 | — | — | — | 94.5 | 0.5 | 0.042 | 0.125 | 0.149 | 0.004 | −0.004 | −0.008 |
| Co. Example 3-6 | 10 | — | — | — | 89.5 | 0.5 | 0.041 | 0.124 | 0.149 | 0.004 | −0.004 | −0.008 |
| Co. Example 3-7 | 20 | — | — | — | 79.5 | 0.5 | 0.041 | 0.124 | 0.147 | 0.002 | −0.008 | −0.012 |
| Co. Example 3-8 | 40 | — | — | — | 59.5 | 0.5 | 0.039 | 0.122 | 0.144 | 0.001 | −0.010 | −0.014 |
| Co. Example 3-9 | 60 | — | — | — | 39.5 | 0.5 | 0.038 | 0.121 | 0.141 | 0.000 | −0.012 | −0.016 |
| Co. Example 3-10 | — | — | 1 | — | 98.5 | 0.5 | 0.042 | 0.125 | 0.150 | 0.012 | 0.015 | 0.020 |
| Co. Example 3-11 | — | — | 1.5 | — | 98 | 0.5 | 0.042 | 0.125 | 0.151 | 0.012 | 0.015 | 0.020 |
| Co. Example 3-12 | — | — | 3 | — | 96.5 | 0.5 | 0.042 | 0.126 | 0.151 | 0.015 | 0.018 | 0.023 |
| Co. Example 3-13 | — | — | 5 | — | 94.5 | 0.5 | 0.042 | 0.126 | 0.152 | 0.018 | 0.021 | 0.026 |
| Co. Example 3-14 | — | — | 10 | — | 89.5 | 0.5 | 0.042 | 0.128 | 0.154 | 0.025 | 0.028 | 0.033 |
| Co. Example 3-15 | — | — | 20 | — | 79.5 | 0.5 | 0.043 | 0.130 | 0.158 | 0.032 | 0.035 | 0.040 |
| Co. Example 3-16 | — | — | 40 | — | 59.5 | 0.5 | 0.043 | 0.135 | 0.165 | 0.042 | 0.050 | 0.055 |
| Co. Example 3-17 | — | — | 60 | — | 39.5 | 0.5 | 0.044 | 0.140 | 0.173 | 0.048 | 0.055 | 0.060 |

In Table 8, Examples 1-1 to 1-8 and Comparative Examples 1-2 to 1-9, in which the same compositional ratio but different components were used, were compared. Examples 2-1 to 2-8 and Comparative Examples 2-2 to 2-9, in which the same compositional ratio but different components were used, were compared. Examples 3-1 to 3-8 and Comparative Examples 3-2 to 3-9, in which the same compositional ratio but different components were used, were compared. As a result of comparison, it was found that, in comparison with samples containing AgNiO₂, the amount of swelling could be decreased by a maximum of 12% at 30% depth of discharge, a maximum of 6% at 90% depth of discharge, and 8.4% at 110% depth of discharge in samples containing AgCo_{0.10}Ni_{0.90}O₂.

According to Examples 1-1 to 1-8, 2-1 to 2-8, and 3-1 to 3-8, it was found that addition of AgCo_{0.10}Ni_{0.90}O₂ could decrease the amount of swelling by about a maximum of 113% at 30% depth of discharge, about a maximum of 106% at 90% depth of discharge, and about 120% at 110% depth of discharge based on the amounts of change in overall height before and after the discharge at respective depths of discharge. The extent to which the amount of swelling decreased was calculated by the following formula: 100−{([change in overall height during discharge+change in overall height of partially used battery]/change in overall height during discharge)×100} (%)

These effects are favorable in satisfying the requirement set forth in Japanese Industrial Standards (JIS) C8515 that “there should be no deformation that exceeds 0.25 mm from the maximum size”. These effects also help increase the inner volume of the battery and the capacity of the battery.

Measurement Results of Capacity Retention

The measurement results of capacity retention of Examples 1-1 to 3-8 and Comparative Examples 1-1 to 3-17 are shown in Table 9. In Table 9, “Co. Example” represents “Comparative Example”.

TABLE 9

| | | | | | | | Capacity, 0.9 V cut-off | |
|---|---|---|---|---|---|---|---|---|
| | | | | | | | | After 100 days |
| | Cathode mix composition (wt %) | | | | | | | of storage at |
| | AgNiO₂ | AgCo_{0.10}Ni_{0.90}O₂ | AgCuO₂ | Ag₂O | MnO₂ | PTFE | Initial | 60° C. |
| Example 1-1 | — | 1.5 | — | 98 | — | 0.5 | 30.00 | 26.25 |
| Example 1-2 | — | 3 | — | 96.5 | — | 0.5 | 30.14 | 26.38 |
| Example 1-3 | — | 5 | — | 94.5 | — | 0.5 | 30.56 | 26.74 |
| Example 1-4 | — | 10 | — | 89.5 | — | 0.5 | 30.82 | 26.97 |
| Example 1-5 | — | 20 | — | 79.5 | — | 0.5 | 31.04 | 27.16 |
| Example 1-6 | — | 40 | — | 59.5 | — | 0.5 | 31.17 | 27.27 |
| Example 1-7 | — | 60 | — | 39.5 | — | 0.5 | 31.32 | 27.41 |
| Example 1-8 | — | 1 | — | 98.5 | — | 0.5 | 29.40 | 25.72 |
| Co. Example 1-1 | — | — | — | 99.5 | — | 0.5 | 27.00 | 23.63 |
| Co. Example 1-2 | 1 | — | — | 98.5 | — | 0.5 | 28.19 | 24.67 |
| Co. Example 1-3 | 1.5 | — | — | 98 | — | 0.5 | 28.79 | 25.19 |
| Co. Example 1-4 | 3 | — | — | 96.5 | — | 0.5 | 29.37 | 25.70 |
| Co. Example 1-5 | 5 | — | — | 94.5 | — | 0.5 | 29.96 | 26.21 |
| Co. Example 1-6 | 10 | — | — | 89.5 | — | 0.5 | 30.21 | 26.44 |
| Co. Example 1-7 | 20 | — | — | 79.5 | — | 0.5 | 30.43 | 26.62 |
| Co. Example 1-8 | 40 | — | — | 59.5 | — | 0.5 | 30.56 | 26.74 |
| Co. Example 1-9 | 60 | — | — | 39.5 | — | 0.5 | 28.62 | 24.76 |
| Co. Example 1-10 | — | — | 1 | 98.5 | — | 0.5 | 28.24 | 9.88 |
| Co. Example 1-11 | — | — | 1.5 | 98 | — | 0.5 | 28.86 | 10.10 |
| Co. Example 1-12 | — | — | 3 | 96.5 | — | 0.5 | 29.53 | 10.34 |
| Co. Example 1-13 | — | — | 5 | 94.5 | — | 0.5 | 30.22 | 10.58 |
| Co. Example 1-14 | — | — | 10 | 89.5 | — | 0.5 | 30.44 | 10.65 |
| Co. Example 1-15 | — | — | 20 | 79.5 | — | 0.5 | 30.86 | 10.80 |
| Co. Example 1-16 | — | — | 40 | 59.5 | — | 0.5 | 31.65 | 11.08 |
| Co. Example 1-17 | — | — | 60 | 39.5 | — | 0.5 | 32.39 | 11.34 |
| Example 2-1 | — | 1.5 | — | 68 | 30 | 0.5 | 26.73 | 22.72 |
| Example 2-2 | — | 3 | — | 66.5 | 30 | 0.5 | 26.86 | 22.83 |
| Example 2-3 | — | 5 | — | 64.5 | 30 | 0.5 | 27.24 | 23.15 |
| Example 2-4 | — | 10 | — | 59.5 | 30 | 0.5 | 27.48 | 23.36 |
| Example 2-5 | — | 20 | — | 49.5 | 30 | 0.5 | 17.69 | 23.54 |
| Example 2-6 | — | 40 | — | 29.5 | 30 | 0.5 | 27.84 | 23.67 |
| Example 2-7 | — | 60 | — | 9.5 | 30 | 0.5 | 28.98 | 23.79 |
| Example 2-8 | — | 1 | — | 68.5 | 30 | 0.5 | 26.20 | 22.27 |
| Co. Example 2-1 | — | — | — | 69.5 | 30 | 0.5 | 24.06 | 20.45 |
| Co. Example 2-2 | 1 | — | — | 68.5 | 30 | 0.5 | 25.12 | 21.35 |
| Co. Example 2-3 | 1.5 | — | — | 68 | 30 | 0.5 | 25.65 | 21.81 |
| Co. Example 2-4 | 3 | — | — | 66.5 | 30 | 0.5 | 26.18 | 22.25 |
| Co. Example 2-5 | 5 | — | — | 64.5 | 30 | 0.5 | 26.70 | 22.70 |
| Co. Example 2-6 | 10 | — | — | 59.5 | 30 | 0.5 | 26.94 | 22.90 |
| Co. Example 2-7 | 20 | — | — | 49.5 | 30 | 0.5 | 27.15 | 23.08 |
| Co. Example 2-8 | 40 | — | — | 29.5 | 30 | 0.5 | 27.30 | 23.20 |
| Co. Example 2-9 | 60 | — | — | 9.5 | 30 | 0.5 | 25.60 | 21.12 |
| Co. Example 2-10 | — | — | 1 | 68.5 | 30 | 0.5 | 25.17 | 6.29 |
| Co. Example 2-11 | — | — | 1.5 | 68 | 30 | 0.5 | 25.72 | 6.43 |
| Co. Example 2-12 | — | — | 3 | 66.5 | 30 | 0.5 | 26.32 | 6.58 |
| Co. Example 2-13 | — | — | 5 | 64.5 | 30 | 0.5 | 26.94 | 6.74 |
| Co. Example 2-14 | — | — | 10 | 59.5 | 30 | 0.5 | 27.15 | 6.79 |
| Co. Example 2-15 | — | — | 20 | 49.5 | 30 | 0.5 | 27.56 | 6.89 |
| Co. Example 2-16 | — | — | 40 | 29.5 | 30 | 0.5 | 28.34 | 7.08 |
| Co. Example 2-17 | — | — | 60 | 9.5 | 30 | 0.5 | 29.07 | 7.27 |
| Example 3-1 | — | 1.5 | — | — | 98 | 0.5 | 20.19 | 16.65 |
| Example 3-2 | — | 3 | — | — | 96.5 | 0.5 | 20.41 | 16.84 |
| Example 3-3 | — | 5 | — | — | 94.5 | 0.5 | 20.85 | 17.20 |
| Example 3-4 | — | 10 | — | — | 89.5 | 0.5 | 21.45 | 17.70 |
| Example 3-5 | — | 20 | — | — | 79.5 | 0.5 | 22.48 | 18.55 |
| Example 3-6 | — | 40 | — | — | 59.5 | 0.5 | 24.46 | 20.18 |
| Example 3-7 | — | 60 | — | — | 39.5 | 0.5 | 24.58 | 20.28 |
| Example 3-8 | — | 1 | — | — | 98.5 | 0.5 | 19.74 | 16.29 |
| Co. Example 3-1 | — | — | — | — | 99.5 | 0.5 | 18.06 | 14.90 |
| Co. Example 3-2 | 1 | — | — | — | 98.5 | 0.5 | 18.93 | 15.62 |
| Co. Example 3-3 | 1.5 | — | — | — | 98 | 0.5 | 19.37 | 15.98 |
| Co. Example 3-4 | 3 | — | — | — | 96.5 | 0.5 | 19.88 | 16.40 |
| Co. Example 3-5 | 5 | — | — | — | 94.5 | 0.5 | 20.44 | 16.86 |
| Co. Example 3-6 | 10 | — | — | — | 89.5 | 0.5 | 21.03 | 17.35 |
| Co. Example 3-7 | 20 | — | — | — | 79.5 | 0.5 | 22.04 | 18.18 |
| Co. Example 3-8 | 40 | — | — | — | 59.5 | 0.5 | 23.98 | 19.78 |
| Co. Example 3-9 | 60 | — | — | — | 39.5 | 0.5 | 23.34 | 18.90 |
| Co. Example 3-10 | — | — | 1 | — | 98.5 | 0.5 | 18.98 | 2.85 |
| Co. Example 3-11 | — | — | 1.5 | — | 98 | 0.5 | 19.45 | 2.92 |
| Co. Example 3-12 | — | — | 3 | — | 96.5 | 0.5 | 20.04 | 3.01 |
| Co. Example 3-13 | — | — | 5 | — | 94.5 | 0.5 | 20.70 | 3.11 |
| Co. Example 3-14 | — | — | 10 | — | 89.5 | 0.5 | 21.34 | 3.20 |
| Co. Example 3-15 | — | — | 20 | — | 79.5 | 0.5 | 22.64 | 3.40 |
| Co. Example 3-16 | — | — | 40 | — | 59.5 | 0.5 | 25.29 | 3.79 |
| Co. Example 3-17 | — | — | 60 | — | 39.5 | 0.5 | 28.02 | 4.20 |

In Table 9, Examples 1-1 to 1-8 and Comparative Examples 1-2 to 1-9, in which the same compositional ratio but different components were used, were compared. Examples 2-1 to 2-8 and Comparative Examples 2-2 to 2-9, in which the same compositional ratio but different components were used, were compared. Examples 3-1 to and Comparative Examples 3-2 to 3-9, in which the same compositional ratio but different components were used, were compared. As a result of comparison, it was found that, in comparison with samples containing AgNiO₂, samples containing AgCo_{0.10}Ni_{0.90}O₂ could achieve an increase of about 2% to 9% in volume.

It was confirmed that, in samples containing AgNiO₂, the capacity increased with the amount of AgNiO₂ in the AgNiO₂ content range of 1 to 40 percent by weight but decreased after the AgNiO₂ content reached 60 percent by weight. In contrast, in samples containing AgCo_{0.10}Ni_{0.90}O₂, the capacity increased with the AgCo_{0.10}Ni_{0.90}O₂ content even at a AgCo_{0.10}Ni_{0.90}O₂ content of 60 percent by weight.

As for the capacity after storage, it was confirmed that, in samples containing AgNiO₂, the capacity increased with the amount of AgNiO₂ in the AgNiO₂ content range of 1 to 40 percent by weight but decreased after the AgNiO₂ content reached 60 percent by weight. In contrast, in samples containing AgCo_{0.10}Ni_{0.90}O₂, the capacity increased with the AgCo_{0.10}Ni_{0.90}O₂ content even at a AgCo_{0.10}Ni_{0.90}O₂ content of 60 percent by weight.

Presumably, this was because, in samples containing AgNiO₂, Ni(OH)₂ generated by discharge reaction of AgNiO₂ existed as a resistance component and caused a decrease in efficiency of using the active material at the discharge final stage whereas AgCo_{0.10}Ni_{0.90}O₂ had little such effects and suppressed the decrease in capacity.

It should be noted that although a battery containing AgCuO₂ has a significantly large initial capacity, the cell inner pressure increases due to low hydrogen gas-absorbing ability of AgCuO₂. Moreover, since the volume of MnO₂ increases by discharge, the separator is more strongly pressed against the gasket. As a result, the separator underwent cleavage, minor internal shorts occurred, and the capacity when stored decreased significantly.

Results of Misuse Test

The results of the misuse test of Examples 1-1 to 3-8 and Comparative Examples 1-1 to 3-17 are shown in Table 10. In Table 10, “Co. Example” represents “Comparative Example”.

TABLE 10

| | | | | | | | Charge test in closed | |
|---|---|---|---|---|---|---|---|---|
| | | | | | | | circuit, after 24 H | |
| | Cathode mix composition (wt %) | | | | | | 3 in series, | 4 in series, 1 |
| | AgNiO₂ | AgCo_{0.10}Ni_{0.90}O₂ | AgCuO₂ | Ag₂O | MnO₂ | PTFE | 1 reversed | reversed |
| Example 1-1 | — | 1.5 | — | 98 | — | 0.5 | No burst | No burst |
| Example 1-2 | — | 3 | — | 96.5 | — | 0.5 | No burst | No burst |
| Example 1-3 | — | 5 | — | 94.5 | — | 0.5 | No burst | No burst |
| Example 1-4 | — | 10 | — | 89.5 | — | 0.5 | No burst | No burst |
| Example 1-5 | — | 20 | — | 79.5 | — | 0.5 | No burst | No burst |
| Example 1-6 | — | 40 | — | 59.5 | — | 0.5 | No burst | No burst |
| Example 1-7 | — | 60 | — | 39.5 | — | 0.5 | No burst | No burst |
| Example 1-8 | — | 1 | — | 98.5 | — | 0.5 | No burst | No burst |
| Co. Example 1-1 | — | — | — | 99.5 | — | 0.5 | Burst | Burst |
| Co. Example 1-2 | 1 | — | — | 98.5 | — | 0.5 | Burst | Burst |
| Co. Example 1-3 | 1.5 | — | — | 98 | — | 0.5 | Burst | Burst |
| Co. Example 1-4 | 3 | — | — | 96.5 | — | 0.5 | Burst | Burst |
| Co. Example 1-5 | 5 | — | — | 94.5 | — | 0.5 | Burst | Burst |
| Co. Example 1-6 | 10 | — | — | 89.5 | — | 0.5 | Burst | Burst |
| Co. Example 1-7 | 20 | — | — | 79.5 | — | 0.5 | Burst | Burst |
| Co. Example 1-8 | 40 | — | — | 59.5 | — | 0.5 | Burst | Burst |
| Co. Example 1-9 | 60 | — | — | 39.5 | — | 0.5 | Burst | Burst |
| Co. Example 1-10 | — | — | 1 | 98.5 | — | 0.5 | Burst | Burst |
| Co. Example 1-11 | — | — | 1.5 | 98 | — | 0.5 | Burst | Burst |
| Co. Example 1-12 | — | — | 3 | 96.5 | — | 0.5 | Burst | Burst |
| Co. Example 1-13 | — | — | 5 | 94.5 | — | 0.5 | Burst | Burst |
| Co. Example 1-14 | — | — | 10 | 89.5 | — | 0.5 | Burst | Burst |
| Co. Example 1-15 | — | — | 20 | 79.5 | — | 0.5 | Burst | Burst |
| Co. Example 1-16 | — | — | 40 | 59.5 | — | 0.5 | Burst | Burst |
| Co. Example 1-17 | — | — | 60 | 39.5 | — | 0.5 | Burst | Burst |
| Example 2-1 | — | 1.5 | — | 68 | 30 | 0.5 | No burst | No burst |
| Example 2-2 | — | 3 | — | 66.5 | 30 | 0.5 | No burst | No burst |
| Example 2-3 | — | 5 | — | 64.5 | 30 | 0.5 | No burst | No burst |
| Example 2-4 | — | 10 | — | 59.5 | 30 | 0.5 | No burst | No burst |
| Example 2-5 | — | 20 | — | 49.5 | 30 | 0.5 | No burst | No burst |
| Example 2-6 | — | 40 | — | 29.5 | 30 | 0.5 | No burst | No burst |
| Example 2-7 | — | 60 | — | 9.5 | 30 | 0.5 | No burst | No burst |
| Example 2-8 | — | 1 | — | 68.5 | 30 | 0.5 | No burst | No burst |
| Co. Example 2-1 | — | — | | 69.5 | 30 | 0.5 | Burst | Burst |
| Co. Example 2-2 | 1 | — | | 68.5 | 30 | 0.5 | Burst | Burst |
| Co. Example 2-3 | 1.5 | — | | 68 | 30 | 0.5 | Burst | Burst |
| Co. Example 2-4 | 3 | — | | 66.5 | 30 | 0.5 | Burst | Burst |
| Co. Example 2-5 | 5 | — | | 64.5 | 30 | 0.5 | Burst | Burst |
| Co. Example 2-6 | 10 | — | | 59.5 | 30 | 0.5 | Burst | Burst |
| Co. Example 2-7 | 20 | — | | 49.5 | 30 | 0.5 | Burst | Burst |
| Co. Example 2-8 | 40 | — | | 29.5 | 30 | 0.5 | Burst | Burst |
| Co. Example 2-9 | 60 | — | | 9.5 | 30 | 0.5 | Burst | Burst |
| Co. Example 2-10 | — | — | 1 | 68.5 | 30 | 0.5 | Burst | Burst |
| Co. Example 2-11 | — | — | 1.5 | 68 | 30 | 0.5 | Burst | Burst |
| Co. Example 2-12 | — | — | 3 | 66.5 | 30 | 0.5 | Burst | Burst |
| Co. Example 2-13 | — | — | 5 | 64.5 | 30 | 0.5 | Burst | Burst |
| Co. Example 2-14 | — | — | 10 | 59.5 | 30 | 0.5 | Burst | Burst |
| Co. Example 2-15 | — | — | 20 | 49.5 | 30 | 0.5 | Burst | Burst |
| Co. Example 2-16 | — | — | 40 | 29.5 | 30 | 0.5 | Burst | Burst |
| Co. Example 2-17 | — | — | 60 | 9.5 | 30 | 0.5 | Burst | Burst |
| Example 3-1 | — | 1.5 | — | — | 98 | 0.5 | No burst | No burst |
| Example 3-2 | — | 3 | — | — | 96.5 | 0.5 | No burst | No burst |
| Example 3-3 | — | 5 | — | — | 94.5 | 0.5 | No burst | No burst |
| Example 3-4 | — | 10 | — | — | 89.5 | 0.5 | No burst | No burst |
| Example 3-5 | — | 20 | — | — | 79.5 | 0.5 | No burst | No burst |
| Example 3-6 | — | 40 | — | — | 59.5 | 0.5 | No burst | No burst |
| Example 3-7 | — | 60 | — | — | 39.5 | 0.5 | No burst | No burst |
| Example 3-8 | — | 1 | — | — | 98.5 | 0.5 | No burst | No burst |
| Co. Example 3-1 | — | — | — | — | 99.5 | 0.5 | Burst | Burst |
| Co. Example 3-2 | 1 | — | — | — | 98.5 | 0.5 | Burst | Burst |
| Co. Example 3-3 | 1.5 | — | — | — | 98 | 0.5 | Burst | Burst |
| Co. Example 3-4 | 3 | — | — | — | 96.5 | 0.5 | Burst | Burst |
| Co. Example 3-5 | 5 | — | — | — | 94.5 | 0.5 | Burst | Burst |
| Co. Example 3-6 | 10 | — | — | — | 89.5 | 0.5 | Burst | Burst |
| Co. Example 3-7 | 20 | — | — | — | 79.5 | 0.5 | Burst | Burst |
| Co. Example 3-8 | 40 | — | — | — | 59.5 | 0.5 | Burst | Burst |
| Co. Example 3-9 | 60 | — | — | — | 39.5 | 0.5 | Burst | Burst |
| Co. Example 3-10 | — | — | 1 | — | 98.5 | 0.5 | Burst | Burst |
| Co. Example 3-11 | — | — | 1.5 | — | 98 | 0.5 | Burst | Burst |
| Co. Example 3-12 | — | — | 3 | — | 96.5 | 0.5 | Burst | Burst |
| Co. Example 3-13 | — | — | 5 | — | 94.5 | 0.5 | Burst | Burst |
| Co. Example 3-14 | — | — | 10 | — | 89.5 | 0.5 | Burst | Burst |
| Co. Example 3-15 | — | — | 20 | — | 79.5 | 0.5 | Burst | Burst |
| Co. Example 3-16 | — | — | 40 | — | 59.5 | 0.5 | Burst | Burst |
| Co. Example 3-17 | — | — | 60 | — | 39.5 | 0.5 | Burst | Burst |

When three or more batteries are connected in series and one is connected in reverse, the battery connected in reverse becomes charged. Although cylindrical batteries are designed to release pressure when the inner pressure is excessively high, button-type alkaline batteries are not designed to be charged and it is known that in some cases button-type alkaline batteries burst as they are charged.

As shown in Table 10, button-type alkaline batteries containing did not burst in the misuse test. This is presumably because AgCo_{0.10}Ni_{0.90}O₂ having significantly high hydrogen gas-absorbing ability suppresses the increase in inner pressure caused by hydrogen gas generated. Thus, it is presumed that the damage on appliances caused by misuse can be prevented.

Evaluation

It was found from the measurement results described above that a button-type alkaline battery that use a cathode mix containing at least one of silver oxide (Ag₂O) and manganese dioxide (MnO₂), and AgCo_{0.10}Ni_{0.90}O₂ could suppress changes in battery dimensions. Thus, the internal shorts and damage on the appliances that use the battery could be avoided. Such an effect was particularly notable when 1.5 to 60 percent by weight of AgCo_{0.10}Ni_{0.90}O₂ was contained relative to the cathode mix.

The samples containing AgCo_{0.10}Ni_{0.90}O₂ suppressed an increase in inner pressure of the battery as expected, and their leakage resistance was superior to that of Comparative Examples equivalent to currently available products. Thus, it was confirmed that these samples could achieve battery characteristics superior to those of Comparative Examples equivalent to currently available products in terms of higher current, higher electrical capacity, and longer lifetime.

The evaluation results of physical properties of Test Examples showed that the properties could be further improved by increasing the Co content in the silver-cobalt-nickel compound oxide represented by formula (1), i.e., AgₓCo_{y}Ni_{z}O₂ (where x+y+z 2, x≦1.10, and y≧0.01).

It should be understood that the scope of the present application is not limited by the embodiments and examples described above, and various modifications and alterations may occur without departing from the scope of the present application. For example, although a button-type alkaline battery is described as one embodiment above, the type of battery is not limited to this. For example, the same advantages can be achieved with cylindrical alkaline batteries. In practical application, a cellophane film or a laminate film obtained by graft-polymerization of a cellophane film and polyethylene is preferably used as the separator in the structure described in Japanese Unexamined Patent Application Publication No. 2002-117859. This is to prevent a decrease in capacity by battery internal shorts caused by precipitation of Ag, which is a reaction product derived from a silver cobalt nickel oxide, on the anode.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An alkaline battery comprising:
a cathode mix containing a compound oxide of silver, cobalt, and nickel represented by formula (1):
AgₓCo_{y}Ni_{z}O₂ (1)
wherein x+y+z=2, x≦1.10, y>0.

2. The alkaline battery according to claim 1, further comprising:
a cathode can in which the cathode mix is disposed, the cathode can having an open end; and
an anode cup that seals the open end of the cathode can,
wherein the alkaline battery is of a button type.

3. The alkaline battery according to claim 2, wherein the compound oxide of silver, cobalt, and nickel represented by formula (1) satisfies y≧0.01.

4. The alkaline battery according to claim 2, wherein the cathode mix further contains at least one of silver oxide and manganese dioxide.

5. The alkaline battery according to claim 2, wherein the cathode mix further contains manganese dioxide.

6. The alkaline battery according to claim 2, wherein the cathode mix contains 1.5 to 60 percent by weight of the compound oxide of silver, cobalt, and nickel.

7. The alkaline battery according to claim 2, further comprising an anode mix containing a zinc or zinc alloy powder that is mercury-free, the anode mix being disposed in the anode cup.

8. The alkaline battery according to claim 7, wherein an open end of the anode cup is folded to have a U-shaped cross-section to form a turnup portion, and
a coating layer composed of a metal having a hydrogen overvoltage higher than that of copper is disposed on a region of an inner surface of the anode cup excluding a bottom and an outer turnup portion of the turnup portion of the anode cup.

9. The alkaline battery according to claim 8, wherein the coating layer is composed of tin.
